(19) United States
(12) Patent Application Publication
(10) Pub. No.: US 2026/0315878 A1
(43) Pub. Date: Oct. 15, 2026

(54) MULTI-PIECE SOLID GOLF BALL

(71) Applicant: BRIDGESTONE SPORTS CO., LTD., Tokyo (JP)

(72) Inventor: Hideo WATANABE, Chichibushi (JP)

(73) Assignee: BRIDGESTONE SPORTS CO., LTD., Tokyo (JP)

(21) Appl. No.: 19/576,488

(22) Filed: Mar. 24, 2026

(30) Foreign Application Priority Data
Apr. 15, 2025 (JP) 2025-066688

(51) Int. Cl. A63B 37/00; C08L 9/00; C08L 75/08

(52) U.S. Cl. CPC A63B 37/0076; A63B 37/0063; A63B 37/0065; A63B 37/0082; A63B 37/00921; C08L 9/00; C08L 75/08

(57) ABSTRACT

A golf ball including a core, a surrounding layer, an intermediate layer, and a cover, wherein a relationship of surface hardnesses of spheres encasing these layers satisfies the following condition:

center hardness of core<surface hardness of core<surface hardness of surrounding layer-encased sphere<surface hardness of intermediate layer-encased sphere>surface hardness of ball
and in a hardness profile of the core, letting H100 be a Shore C hardness at the core surface, H87.5, H75, H62.5, H50, H37.5, H25, and H12.5 be Shore C hardnesses at an 87.5% outer position, a 75% outer position, a 62.5% outer position, a 50% outer position, a 37.5% outer position, a 25% outer position, and a 12.5% outer position of a core radius from the core center, respectively, and H0 be a Shore C hardness at the core center, the following three conditions are satisfied:

(H87.5−H50)/(H50−H12.5)≥4.0

(H100−H75)>(H75−H50)>(H50−H25)>(H25−H0)

(H87.5−H0)≥20.

### CROSS-REFERENCE TO RELATED APPLICATIONS

This non-provisional application claims priority under 35 U.S.C. § 119 (a) on Patent Application No. 2025-066688 filed in Japan on Apr. 15, 2025, the entire contents of which are hereby incorporated by reference.

### TECHNICAL FIELD

The present invention relates to a multi-piece solid golf ball composed of at least four layers including a core, a surrounding layer, an intermediate layer, and a cover.

### BACKGROUND ART

Conventionally, many attempts for designing a ball into a layer construction have been made, and many balls that satisfy not only professionals but also general amateur golfers from beginners to skilled amateur golfers have been developed. For example, functional multi-piece solid golf balls in which a material hardness and a surface hardness of each layer of a core, a surrounding layer, an intermediate layer, and a cover (outermost layer) are optimized have been widely used. Focusing on a core hardness profile that accounts for most of a volume of the ball, several techniques have been proposed to provide high-performance golf balls by designing core internal hardness in various aspects.

Examples of such technical documents include golf balls described in Patent Documents 1 to 10 below. These golf balls may be used by skilled amateur golfers, and are prior art in which flight is pursued using a urethane cover (outermost layer) that is softer than the intermediate layer. As described above, conventionally, development of a golf ball that pursues distance on full shots while having high controllability in the short game has been studied for a long time, but it is desirable to further reduce a spin rate on full shots, and to obtain controllability in the short game and an excellent distance. In addition, it is also desirable to provide a golf ball which is targeted not only at skilled amateur golfers but also golfers having a less high head speed, and which may obtain a superior distance on full shots with a driver (W #1) and an iron in a wide head speed region.

### CITATION LIST

Patent Document 1: JP-A 2007-319667
Patent Document 2: JP-A 2007-330789
Patent Document 3: JP-A 2008-068077
Patent Document 4: JP-A 2009-095364
Patent Document 5: JP-A 2012-071163
Patent Document 6: JP-A 2016-101254
Patent Document 7: JP-A 2016-116627
Patent Document 8: JP-A 2021-176378
Patent Document 9: JP-A 2021-176380
Patent Document 10: JP-A 2021-17381

### SUMMARY OF THE INVENTION

The present invention has been made in view of the above circumstances, and it is an object of the present invention to provide a multi-piece solid golf ball which has high spin performance in the short game and which may obtain an excellent distance with all club numbers by pursuing a low spin rate on full shots with a driver (W #1) and an iron.

As a result of intensive studies to achieve the above object, the present inventor has found that in a multi-piece solid golf ball including a core, a surrounding layer, an intermediate layer, and a cover, the core is formed of a rubber composition, the surrounding layer is formed of a resin composition into a single layer or a plurality of layers, both the intermediate layer and the cover are formed of a resin composition into a single layer, and a relationship among surface hardnesses of the core, the surrounding layer, the intermediate layer, and the ball satisfies the following condition:

center hardness of core<surface hardness of core<surface hardness of surrounding layer-encased sphere<surface hardness of intermediate layer-encased sphere>surface hardness of ball (where hardnesses indicate Shore D hardness).

Further, in a core hardness profile, letting a Shore C hardness at the core surface be H100, the Shore C hardness at a position outside by 87.5% of a core radius from the core center be H87.5, the Shore C hardness at a position outside by 75% of the core radius from the core center be H75, the Shore C hardness at a position outside by 62.5% of the core radius from the core center be H62.5, the Shore C hardness at a position outside by 50% of the core radius from the core center be H50, the Shore C hardness at a position outside by 37.5% of the core radius from the core center be H37.5, the Shore C hardness at a position outside by 25% of the core radius from the core center be H25, the Shore C hardness at a position outside by 12.5% of the core radius from the core center be H12.5, and the Shore C hardness at the core center be H0, the following three conditions are satisfied:

(H87.5−H50)/(H50−H12.5)≥4.0

(H100−H75)>(H75−H50)>(H50−H25)>(H25−H0)

(H87.5−H0)≥20.

The present inventor has found that by configuring a golf ball so as to satisfy the conditions described above, a spin rate of the ball on full shots is reduced in a wide head speed region, a distance on shots with a driver (W #1) and an iron is sufficiently increased, and the ball has high spin performance in the short game, and thus has completed the present invention.

That is, the golf ball of the present invention is a golf ball that has high spin performance in the short game and pursues a low spin rate on full shots with a driver (W #1) and an iron, and has a core structure in which an amount of sulfur and water is increased as compared with a conventional case in the blending of the core into the rubber composition to sufficiently increase a difference in hardness between the surface and the center of the core while maintaining a shape of the hardness profile of the core of the rubber composition containing the conventional blending of water, thereby achieving a low spin rate on full shots. In addition, in order to prevent deterioration of a durability to repeated impact, a surrounding layer made of resin is introduced between the core and the intermediate layer to produce a four-piece ball structure, and a surrounding layer made of a resin material having a high specific gravity by adding a filler such as barium sulfate to both the intermediate layer and the surrounding layer is incorporated. As a result, the golf ball of the present invention may compensate for deterioration of the durability to repeated impact, and may maintain a straightness of rolling on shots with a putter, in particular, if eccentricity occurs during the molding of the surrounding layer, the intermediate layer, or the cover.

Accordingly, the present invention provides a multi-piece solid golf ball including
a core, a surrounding layer, an intermediate layer, and a cover, wherein the core is formed of a rubber composition, the surrounding layer is formed of a resin composition into a single layer or a plurality of layers, the intermediate layer and the cover are both formed of a resin composition into a single layer, and a relationship among surface hardnesses of the core, the surrounding layer, the intermediate layer, and the ball satisfies the following condition:

center hardness of core<surface hardness of core<surface hardness of surrounding layer-encased sphere<surface hardness of intermediate layer-encased sphere>surface hardness of ball (where hardnesses indicate Shore D hardness).

Further, in a hardness profile of the core, letting a Shore C hardness at the core surface be H100, the Shore C hardness at a position outside by 87.5% of a core radius from the core center be H87.5, the Shore C hardness at a position outside by 75% of the core radius from the core center be H75, the Shore C hardness at a position outside by 62.5% of the core radius from the core center be H62.5, the Shore C hardness at a position outside by 50% of the core radius from the core center be H50, the Shore C hardness at a position outside by 37.5% of the core radius from the core center be H37.5, the Shore C hardness at a position outside by 25% of the core radius from the core center be H25, the Shore C hardness at a position outside by 12.5% of the core radius from the core center be H12.5, and the Shore C hardness at the core center be H0, the following three conditions are satisfied:

(H87.5−H50)/(H50−H12.5)≥4.0

(H100−H75)>(H75−H50)>(H50−H25)>(H25−H0)

(H87.5−H0)≥20.

In a preferred embodiment of the golf ball according to the invention, letting a deflection when the core is compressed under a final load of 1,275 N (130 kgf) from an initial load of 98 N (10 kgf) be T (mm), the following condition is satisfied:

(H87.5−H0)×T≥75.

In another preferred embodiment of the inventive golf ball, in the hardness profile of the core, the following condition is satisfied:

(H100−H0)≥26.

In yet another preferred embodiment, in the hardness profile of the core, the following condition is satisfied:

13≤(H100−H75)≤20.

In still another preferred embodiment, in the hardness profile of the core, the following condition is satisfied:

8≤(H75−H50)≤15.

In a further preferred embodiment, a difference between a specific gravity of the core and a specific gravity of the surrounding layer is within ±0.10, and a difference between the specific gravity of the core and a specific gravity of the cover is within ±0.10.

In a yet further preferred embodiment, a difference between the specific gravity of the surrounding layer and a specific gravity of the intermediate layer is within ±0.10, a difference between the specific gravity of the surrounding layer and the specific gravity of the cover is within ±0.10, and a difference between the specific gravity of the intermediate layer and the specific gravity of the cover is within =0.10.

In a still further preferred embodiment, in the specific gravity of the core, the specific gravity of the surrounding layer, the specific gravity of the intermediate layer, and the specific gravity of the cover, a difference between a maximum value and a minimum value among specific gravity differences between these members is within =0.10.

In another preferred embodiment, the core is formed of a rubber composition that includes the following components (A) to (E):
(A) a base rubber,
(B) an organic peroxide,
(C) water or a monocarboxylic acid metal salt,
(D) sulfur, and
(E) an organosulfur compound,

wherein a compounding amount of the component (C) is at least 0.4 parts by weight and a compounding amount of the component (D) is at least 0.024 parts by weight per 100 parts by weight of the component (A).

In yet another preferred embodiment, the cover is formed by injection-molding a single resin blend containing a thermoplastic polyurethane (I) and a polyisocyanate compound (II) as principal components, and at least a part of the resin blend contains a polyisocyanate compound in which all isocyanate groups in one molecule remain in an unreacted state.

### Advantageous Effects of the Invention

According to the multi-piece solid golf ball of the present invention, while having high spin performance in the short game, it is possible to further reduce the spin rate on full shots with a driver (W #1) and an iron, and to increase the distance.

### BRIEF DESCRIPTION OF THE DRAWINGS

FIG. 1 is a schematic cross-sectional view of a golf ball according to one embodiment of the present invention.

FIG. 2 is a graph showing core hardness profile data in Example 1.

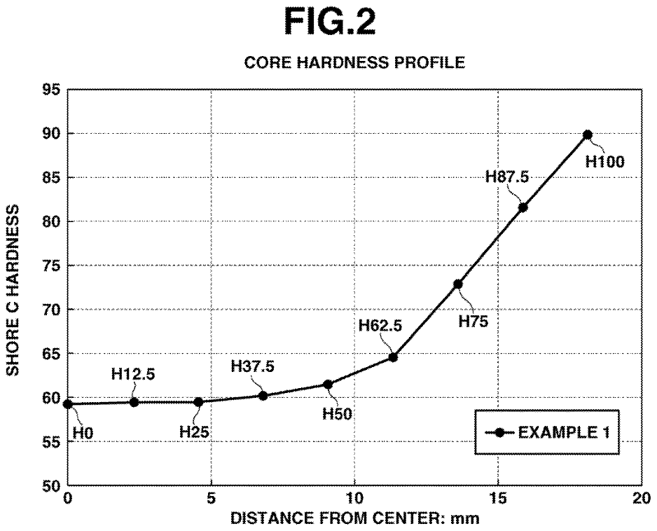

FIGS. 3A and 3B are plan views illustrating a mode (pattern) of dimples common to Examples and Comparative Examples.

FIG. 4 is a graph showing core hardness profiles in Examples 1 to 3 and Comparative Example 1.

FIG. 5 is a graph showing core hardness profiles in Comparative Examples 2 to 6.

### DETAILED DESCRIPTION OF THE INVENTION

Hereinafter, the present invention is described in more detail.

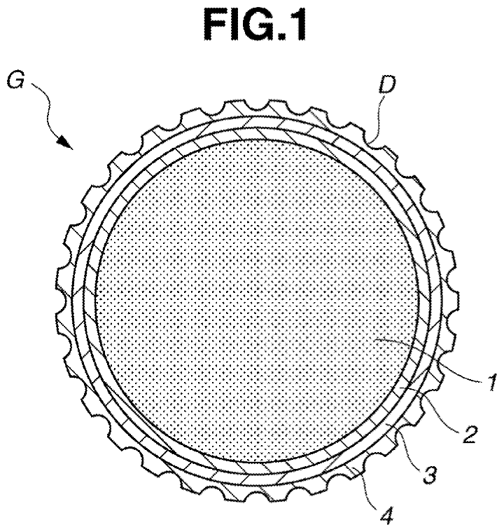

A golf ball according to the present invention has a core, a surrounding layer, an intermediate layer, and a cover, and an example thereof is shown in FIG. 1, for example. A golf ball G shown in FIG. 1 is the golf ball G having four layers including a core 1, a surrounding layer 2 encasing the core, an intermediate layer 3 encasing the surrounding layer, and a cover 4 encasing the intermediate layer. A large number of dimples D are typically formed on a surface of the cover 4. Although not particularly illustrated, a coating film layer is typically formed on the surface of the cover 4 by coating. The cover 4 is positioned at an outermost layer in the layer construction of the golf ball except for the coating film layer. The core 1 or the surrounding layer 2 is not limited to a single layer and may be formed in a plurality of layers of at least two layers, but the intermediate layer 3 or the cover 4 is formed in a single layer. Hereinafter, each of the above layers is described in detail.

The core is formed in a single layer or a plurality of layers. From the viewpoint of obtaining good durability to repeated impact, the core is preferably formed in a single layer.

A diameter of the core is not particularly limited, although the diameter is preferably at least 35.1 mm, more preferably at least 35.3 mm, and still more preferably at least 35.4 mm, and the upper limit value is preferably not more than 38.0 mm, more preferably not more than 37.6 mm, and still more preferably not more than 37.2 mm. If the diameter of the core is too small, an initial velocity of the ball may become low, a hardness of an entire ball may become too hard, that is, a deflection may become small, and a spin rate on full shots increases, so that an intended distance may not be attainable. On the other hand, if the diameter of the core is too large, the spin rate on full shots increases, so that the intended distance may not be attainable, particularly on shots with a driver (W #1) at a head speed of not more than 40 m/s and on shots with an iron, and a durability to cracking on repeated impact may worsen.

The deflection (mm) when the core is compressed under a final load of 1,275 N (130 kgf) from an initial load of 98 N (10 kgf) is not particularly limited, although the deflection is preferably at least 2.9 mm, more preferably at least 3.1 mm, and still more preferably at least 3.3 mm, and the upper limit value is preferably not more than 4.3 mm, more preferably not more than 4.1 mm, and still more preferably not more than 3.9 mm. If the deflection of the core is too small, that is, the core is too hard, the spin rate may rise excessively, a good distance may not be achieved, and a feel at impact may be excessively hard. On the other hand, if the deflection of the core is too large, that is, if the core is too soft, a rebound may become too low and the distance may not be increased, the feel at impact may be too soft, and the durability to cracking on repeated impact may worsen.

The core has a specific gravity which, although not particularly limited, is preferably at least 1.08, more preferably at least 1.11, and still more preferably at least 1.14. The upper limit is preferably not more than 1.25, more preferably not more than 1.23, and still more preferably not more than 1.20. If the above value is too small, an amount of zinc oxide added decreases, and the deflection and a cross-sectional hardness and surface hardness at each position may not be stable in production. If the above value is too large, the weight as a ball increases, and the Rules of Golf may not be satisfied.

Next, the core hardness profile is described. It is noted that the hardness of the core described below means Shore C hardness. The Shore C hardness is a hardness value measured with a Shore C durometer conforming to the ASTM D2240 standard.

In the following description of the core hardness profile, the Shore C hardness of a core surface is defined as H100, a Shore C hardness at a position outside by 87.5% of a core radius from a core center is defined as H87.5, a Shore C hardness at a position outside by 75% of the core radius from the core center is defined as H75, a Shore C hardness at a position outside by 62.5% of the core radius from the core center is defined as H62.5, a Shore C hardness at a position outside by 50% of the core radius from the core center is defined as H50, a Shore C hardness at a position outside by 37.5% of the core radius from the core center is defined as H37.5, a Shore C hardness at a position outside by 25% of the core radius from the core center is defined as H25, a Shore C hardness at a position outside by 12.5% of the core radius from the core center is defined as H12.5, and the Shore C hardness at the core center is defined as H0.

The surface hardness of the core (H100) is not particularly limited, although the surface hardness may be preferably at least 80, more preferably at least 82, and still more preferably at least 84. The upper limit is not particularly limited, although the upper limit may be preferably not more than 94, more preferably not more than 92, and still more preferably not more than 90. If this value is too small, the rebound of the core may become too low, the spin rate of the ball on full shots may increase, and the intended distance may not be attainable on shots with a driver (W #1) and with an iron. On the other hand, if this value is too large, the durability to cracking on repeated impact may worsen, and the feel at impact may be too hard.

The position hardness (H87.5) outside by 87.5% of the core radius from the core center is not particularly limited, although the position hardness may be preferably at least 72, more preferably at least 74, and still more preferably at least 76. The upper limit is also not particularly limited, although the upper limit may be preferably not more than 86, more preferably not more than 84, and still more preferably not more than 82. Hardnesses that deviate from these values may lead to undesirable results similar to those described above for the core surface hardness (H100).

The position hardness (H75) outside by 75% of the core radius from the core center is not particularly limited, although the position hardness may be preferably at least 65, more preferably at least 67, and still more preferably at least 69. The upper limit is also not particularly limited, although the upper limit may be preferably not more than 77, more preferably not more than 75, and still more preferably not more than 73. Hardnesses that deviate from these values may lead to undesirable results similar to those described above for the core surface hardness (H100).

The position hardness (H62.5) outside by 62.5% of the core radius from the core center is not particularly limited, although the position hardness may be preferably at least 57, more preferably at least 59, and still more preferably at least 61. The upper limit is also not particularly limited, although the upper limit may be preferably not more than 69, more preferably not more than 67, and still more preferably not more than 65. Hardnesses that deviate from these values may lead to undesirable results similar to those described above for the core surface hardness (H100).

The position hardness (H50) outside by 50% of the core radius from the core center is not particularly limited, although the position hardness may be preferably at least 54, more preferably at least 56, and still more preferably at least 58. The upper limit is also not particularly limited, although the upper limit may be preferably not more than 66, more preferably not more than 64, and still more preferably not more than 62. If this value is too large, the spin rate increases on full shots, the intended distance may not be attainable on shots with a driver (W #1) and on full shots with an iron, or the feel at impact may become too hard. On the other hand, if this value is too small, the rebound of the core may become low, and in particular, the intended distance may not be attainable on shots with a driver (W #1) at a head speed of at least 45 m/s, and the durability to cracking on repeated impact may worsen.

The position hardness (H37.5) outside by 37.5% of the core radius from the core center is not particularly limited, although the position hardness may be preferably at least 52, more preferably at least 54, and still more preferably at least 56. The upper limit is also not particularly limited, although the upper limit may be preferably not more than 65, more preferably not more than 63, and still more preferably not more than 61. Hardnesses that deviate from these values may lead to undesirable results similar to those described above for the position hardness (H50) outside by 50% of the core radius from the core center.

The position hardness (H25) outside by 25% of the core radius from the core center is not particularly limited, although the position hardness may be preferably at least 51, more preferably at least 53, and still more preferably at least 55. The upper limit is also not particularly limited, although the upper limit may be preferably not more than 64, more preferably not more than 62, and still more preferably not more than 60. Hardnesses that deviate from these values may lead to undesirable results similar to those described above for the position hardness (H50) outside by 50% of the core radius from the core center.

The position hardness (H12.5) outside by 12.5% of the core radius from the core center is not particularly limited, although the position hardness may be preferably at least 51, more preferably at least 53, and still more preferably at least 55. The upper limit is also not particularly limited, although the upper limit may be preferably not more than 64, more preferably not more than 62, and still more preferably not more than 60. Hardnesses that deviate from these values may lead to undesirable results similar to those described above for the position hardness (H50) outside by 50% of the core radius from the core center.

The center hardness (H0) of the core is not particularly limited, although the center hardness may be preferably at least 50, more preferably at least 52, and still more preferably at least 54. The upper limit is also not particularly limited, although the upper limit may be preferably not more than 64, more preferably not more than 62, and still more preferably not more than 60. Hardnesses that deviate from these values may lead to undesirable results similar to those described above for the position hardness (H50) outside by 50% of the core radius from the core center.

A value of a hardness difference (H87.5−H0) between H87.5 and H0 preferably satisfies the following condition.

(H87.5−H0)≥20

The value of (H87.5−H0) in the above condition is preferably at least 20, more preferably at least 21, and still more preferably at least 22, and the upper limit value is preferably not more than 28, more preferably not more than 26, and still more preferably not more than 24. If this value is too large, the durability to cracking on repeated impact may worsen, and in particular, an actual initial velocity on shots with a driver (W #1) at a head speed of at least 45 m/s may be lowered, so that the intended distance may not be attainable. On the other hand, if this value is too small, the spin rate of the ball on full shots with a driver (W #1) and an iron may increase, and the intended distance may not be attainable.

In addition, the following condition is preferably satisfied.

(H100−H0)≥26

The value of (H100−H0) in the above condition, that is, a difference in hardness between the surface and the center of the core, is preferably at least 26, more preferably at least 28, and still more preferably at least 29 on the Shore C hardness scale, and the upper limit value is preferably not more than 35, more preferably not more than 33, and still more preferably not more than 31. The Shore D hardness is preferably at least 20, more preferably at least 21, and still more preferably at least 22, and the upper limit value is preferably not more than 27, more preferably not more than 25, and still more preferably not more than 24. If this value is too large, the durability to cracking on repeated impact may worsen, and in particular, the actual initial velocity on shots with a driver (W #1) at a head speed of at least 45 m/s may be lowered, so that the intended distance may not be attainable. On the other hand, if this value is too small, the spin rate of the ball on full shots with a driver (W #1) and an iron may increase, and the intended distance may not be attainable.

In addition, the following condition is preferably satisfied.

(H87.5−H50)/(H50−H12.5)≥4.0

The above condition means that a hardness gradient becomes larger than a hardness gradient of a core containing conventional water. The value of (H87.5−H50)/(H50-H12.5) in the above condition is preferably at least 4.0, more preferably at least 5.5, and still more preferably at least 7.0, and the upper limit value is preferably not more than 40.0, more preferably not more than 35.0, and still more preferably not more than 30.5. If this value is too large, the durability to cracking on repeated impact may worsen, and in particular, an actual initial velocity on shots with a driver (W #1) at a head speed of at least 45 m/s may be lowered, so that the intended distance may not be attainable. On the other hand, if this value is too small, the spin rate of the ball on full shots with a driver (W #1) and an iron may increase, and the intended distance may not be attainable.

Further, the following condition is preferably satisfied.

(H100−H75)>(H75−H50)>(H50−H25)>(H25−H0)

The above condition is a graph showing hardness in an upward-sloping manner, and means that the hardness gradient gradually increases. If the above condition is not satisfied, the spin rate of the ball on full shots may increase, and the intended distance may not be attainable.

A value obtained by subtracting the value of (H75−H50) from the value of (H100−H75) is preferably at least 1.0, more preferably at least 2.0, and still more preferably at least 3.0, and the upper limit value is preferably not more than 8.0, more preferably not more than 6.5, and still more preferably not more than 6.0.

A value obtained by subtracting the value of (H50−H25) from the value of (H75−H50) is preferably at least 7.5, more preferably at least 8.5, and still more preferably at least 9.0, and the upper limit value is preferably not more than 14.0, more preferably not more than 13.0, and still more preferably not more than 12.0.

A value obtained by subtracting the value of (H25−H0) from the value of (H50−H25) is preferably at least 0, more preferably at least 0.1, and still more preferably at least 0.2, and the upper limit value is preferably not more than 4.0, more preferably not more than 3.0, and still more preferably not more than 2.0.

If these values are too large, the durability to cracking on repeated impact may worsen, and in particular, the actual initial velocity on shots with a driver (W #1) at a head speed of at least 45 m/s may be lowered, so that the intended distance may not be attainable. On the other hand, if these values are too small, the spin rate of the ball on full shots with a driver (W #1) and an iron may increase, and the intended distance may not be attainable.

The value of (H100−H75) is preferably at least 13.0, more preferably at least 13.5, and still more preferably at least 14.0, and the upper limit value is preferably not more than 20.0, more preferably not more than 19.0, and still more preferably not more than 18.0. The fact that this value is sufficiently large as described above means that the hardness gradient near the core surface is large in the core hardness profile. The value of (H75−H50) is preferably at least 8.0, more preferably at least 9.5, and still more preferably at least 11.0, and the upper limit value is preferably not more than 15.0, more preferably not more than 13.7, and still more preferably not more than 12.5. If these values are too large, the durability to cracking on repeated impact may worsen, and in particular, the actual initial velocity on shots with a driver (W #1) at a head speed of at least 45 m/s may be lowered, so that the intended distance may not be attainable. On the other hand, if these values are too small, the spin rate on full shots increases, and the intended distance may not be attainable on full shots with a driver (W #1) and an iron.

The value of (H50−H25) is preferably at least 0, more preferably at least 0.3, and still more preferably at least 0.5, and the upper limit value is preferably not more than 5.0, more preferably not more than 3.7, and still more preferably not more than 2.5. The value of (H25−H0) is preferably at least 0, more preferably at least 0.2, and still more preferably at least 0.3, and the upper limit value is preferably not more than 5.0, more preferably not more than 2.0, and still more preferably not more than 1.0. If these values are too large, the spin rate on full shots increases, and the intended distance may not be attainable on full shots with a driver (W #1) and an iron. On the other hand, if these values are too small, the durability to cracking on repeated impact may worsen.

Letting the deflection when the core is compressed under a final load of 1,275 N (130 kgf) from an initial load of 98 N (10 kgf) be T (mm), the following condition is preferably satisfied:

(H87.5−H0)×T>75. In general, as the value of the deflection of the core increases, the value of (H87.5−H0) decreases. However, the present invention is characterized in that the hardness gradient is large although the core is soft (the deflection is large). The above condition is a condition indicating a magnitude of the value of (H87.5−H0) in consideration of the deflection of the core. The value of (H87.5−H0)×T in the above condition is preferably at least 75, more preferably at least 76, and still more preferably at least 77, and the upper limit value is preferably not more than 100, more preferably not more than 95, and still more preferably not more than 90. If this value is too large, the durability to cracking on repeated impact may worsen, and in particular, the actual initial velocity on shots with a driver (W #1) at a head speed of at least 45 m/s may be lowered, so that the intended distance may not be attainable. On the other hand, if this value is too small, the spin rate on full shots increases, and the intended distance may not be attainable on full shots with a driver (W #1) and an iron.

As a material of the core having the hardness profile described above, a rubber material is preferably used as a chief material. If the core is not formed of a rubber material, the rebound may be reduced, and a good distance of the ball may not be achieved. Specifically, the rubber material contains a base rubber as a chief material, and a co-crosslinking agent, an organic peroxide, an inert filler, an organosulfur compound, or the like may be blended with the base rubber to prepare a rubber composition for the core.

The core is particularly preferably formed of a rubber composition containing the following components (A) to (E):
(A) a base rubber,
(B) an organic peroxide,
(C) water or a monocarboxylic acid metal salt,
(D) sulfur, and
(E) an organosulfur compound.

As the base rubber (A), polybutadiene is preferably used. As the type of polybutadiene, a commercially available product may be used, and examples thereof include BR01, BR51, and BR730 (manufactured by JSR Corporation). The proportion of polybutadiene in the base rubber is preferably 60 wt % or more, and more preferably 80 wt % or more. In addition to the polybutadiene, other rubber components are included in the base rubber as long as the effect of the present invention is not impaired. Examples of the rubber component other than the polybutadiene include a polybutadiene other than the polybutadiene described above, and other diene rubbers such as styrene-butadiene rubber, natural rubber, isoprene rubber, and ethylene-propylene-diene rubber.

The organic peroxide (B) is suitably used as a co-crosslinking initiator. Specifically, commercially available organic peroxides can be used, and for example, Percumyl D, Perhexa C-40, Perhexa 3M (all manufactured by NOF Corporation), and Luperco 231XL (manufactured by AtoChem Corporation) can be suitably used. These may be used singly, or two or more may be used in combination. The compounding amount of the organic peroxide is preferably 0.1 parts by weight or more, more preferably 0.3 parts by weight or more, and even more preferably 0.5 parts by weight or more, and the upper limit is preferably 5 parts by weight or less, more preferably 4 parts by weight or less, even more preferably 3 parts by weight or less, and most preferably 2.5 parts by weight or less per 100 parts by weight of the base rubber. If the compounding amount is too large or too small, it may not be possible to obtain suitable feel at impact, durability, and rebound.

The water (C), although not particularly limited, may be distilled water or tap water, but it is particularly suitable to employ distilled water free of impurities. A compounding amount of the water is preferably at least 0.4 parts by weight, more preferably at least 0.5 parts by weight, and still more preferably at least 0.6 parts by weight per 100 parts by weight of the base rubber, and the upper limit is preferably not more than 1.5 parts by weight, more preferably not more than 1.0 part by weight, and still more preferably not more than 0.8 parts by weight. If the compounding amount is too small, an intended core hardness profile may not be created, and the spin rate of the ball may not be reduced on full shots. On the other hand, if the compounding amount is too large, the durability to cracking on repeated impact may worsen, and in particular, the actual initial velocity on shots with a driver (W #1) at a head speed of at least 45 m/s is lowered, and the intended distance may not be attainable.

By blending the water or a material containing water as the component (C) directly into the core material, decomposition of the organic peroxide during core formulation may be promoted. In addition, it is known that the decomposition efficiency of the organic peroxide in the core-forming rubber composition changes depending on temperature, and the decomposition efficiency increases as the temperature becomes higher than a certain temperature. If the temperature is too high, the amount of decomposed radicals becomes too large, and the radicals are recombined or deactivated. As a result, fewer radicals act effectively in crosslinking. Here, when decomposition heat is generated by the decomposition of the organic peroxide at the time of core vulcanization, a temperature near the core surface is maintained at substantially the same level as a temperature of a vulcanization mold, but the temperature around the core center is considerably higher than the mold temperature due to an accumulation of decomposition heat by the organic peroxide decomposing from the outside. If the water or a material containing water is directly included in the core, the water acts to promote the decomposition of the organic peroxide, so that the radical reactions as described above can be changed at the core center and the core surface. That is, the decomposition of the organic peroxide is further promoted near the core center, and the deactivation of radicals is further promoted, so that an amount of active radicals is further reduced, and as a result, a core may be obtained in which crosslink densities at the core center and the core surface differ markedly, and a dynamic viscoelasticity of a core center portion is different.

A monocarboxylic acid metal salt may be employed instead of the water. In the monocarboxylic acid metal salt, it is presumed that a carboxylic acid is coordinate-bonded to the metal salt, and the monocarboxylic acid metal salt is distinguished from a dicarboxylic acid metal salt such as zinc diacrylate, which has the chemical formula [CH₂═CHCOO]₂Zn. The monocarboxylic acid metal salt brings water into the rubber composition by a dehydration condensation reaction, so that the same effect as that of the water may be obtained. In addition, since the monocarboxylic acid metal salt may be blended into the rubber composition as powder, a working process may be simplified, and it is easy to uniformly disperse the monocarboxylic acid metal salt in the rubber composition. In order to effectively perform the above reaction, it is necessary to use a mono-salt. A compounding amount of the monocarboxylic acid metal salt is preferably at least 1 part by weight, and more preferably at least 3 parts by weight per 100 parts by weight of the base rubber. As an upper limit, the compounding amount of the monocarboxylic acid metal salt is preferably not more than 60 parts by weight, and more preferably not more than 50 parts by weight per 100 parts by weight of the base rubber. If the compounding amount of the monocarboxylic acid metal salt is too small, it is difficult to obtain an appropriate crosslinking density, and it may not be possible to obtain an adequate golf ball spin rate-lowering effect. If the compounding amount is too large, the core becomes too hard, so that it may be difficult to maintain an appropriate feel at impact.

As the carboxylic acid, an acrylic acid, a methacrylic acid, a maleic acid, a fumaric acid, a stearate, or the like may be used. Examples of a substitute metal include Na, K, Li, Zn, Cu, Mg, Ca, Co, Ni, and Pb, and Zn is preferably used. Specific examples thereof include a zinc monoacrylate and a zinc monomethacrylate, and it is particularly preferable to use a zinc monoacrylate.

By using the sulfur (D), a difference between an inner hardness of the core and an outer hardness of the core may be increased. Specific examples of the sulfur (D) include the trade names “SANMIX S-80 N” (manufactured by Sanshin Chemical Industry Co., Ltd.) and “SULFAX®-5” (manufactured by Tsurumi Chemical Industry Co., Ltd.). A compounding amount of the sulfur may be more than 0 parts by weight, preferably at least 0.024 parts by weight, more preferably at least 0.027 parts by weight, and still more preferably at least 0.030 parts by weight per 100 parts by weight of the base rubber. In addition, although not particularly limited, an upper limit of the compounding amount may be preferably not more than 0.1 parts by weight, more preferably not more than 0.06 parts by weight, and still more preferably not more than 0.05 parts by weight per 100 parts by weight of the base rubber. If the compounding amount is too small, an intended core hardness profile may not be created, and the spin rate of the ball may not be reduced on full shots. On the other hand, if the compounding amount is too large, the durability to cracking on repeated impact may worsen, and in particular, the actual initial velocity on shots with a driver (W #1) at a head speed of at least 45 m/s is lowered, and the intended distance may not be attainable.

A content ratio of the components (D) and (C) in terms of a weight ratio of (D)/(C) is preferably at least 0.005, more preferably at least 0.008, and still more preferably at least 0.010, and an upper limit of the content ratio is preferably not more than 0.200, more preferably not more than 0.100, and still more preferably not more than 0.060. If there is a deviation from the above ranges, it is difficult to achieve an intended core hardness profile, and it may not be possible to achieve both a superior distance due to a low spin rate of the ball on full shots and a good durability on repeated impact. The component (D) means the weight (substantial content) of the sulfur component contained in the product, not the weight of the sulfur product itself.

The organosulfur compound (E) is blended mainly to control the rebound of the core so that the rebound is increased. As the organosulfur compound, specifically, it is recommended to include thiophenol, thionaphthol, halogenated thiophenol, or a metal salt thereof. More specifically, examples of the organosulfur compound include zinc salts such as pentachlorothiophenol, pentafluorothiophenol, pentabromothiophenol, parachlorothiophenol, and pentachlorothiophenol, and any of the following having 2 to 4 sulfur atoms: diphenyl polysulfide, dibenzylpolysulfide, dibenzoylpolysulfide, dibenzothiazoyl polysulfide, and dithiobenzoylpolysulfide. In particular, diphenyl disulfide and the zinc salt of pentachlorothiophenol are preferably used.

A compounding amount of the component (E) is preferably at least 0.1 parts by weight, more preferably at least 0.2 parts by weight, and still more preferably at least 0.3 parts by weight per 100 parts by weight of the base rubber. The upper limit value of the compounding amount of the organosulfur compound is preferably not more than 5 parts by weight, more preferably not more than 4 parts by weight, still more preferably not more than 3 parts by weight, and most preferably not more than 2 parts by weight. If the compounding amount is too large, the core hardness may become too soft, or the intended core hardness profile may not be achieved. On the other hand, if the compounding amount is too small, the rebound of the core is too low, and the intended distance may be unattainable.

Examples of a rubber blending component other than the components (A) to (E) include a co-crosslinking agent, an inert filler, and an antioxidant.

The co-crosslinking agent is an α,β-unsaturated carboxylic acid and/or a metal salt thereof. Specific examples of the unsaturated carboxylic acid include acrylic acid, methacrylic acid, maleic acid, fumaric acid, or the like, and in particular, acrylic acid and methacrylic acid are suitably used. The metal salt of the unsaturated carboxylic acid is not particularly limited, and examples thereof include those obtained by neutralizing the unsaturated carboxylic acid with a desired metal ion. Specific examples thereof include zinc salts and magnesium salts such as methacrylic acid and acrylic acid, and in particular, zinc acrylate is suitably used.

The unsaturated carboxylic acid and/or the metal salt thereof is typically included in an amount of at least 20 parts by weight, preferably at least 25 parts by weight, and more preferably at least 30 parts by weight, and the upper limit is typically not more than 60 parts by weight, preferably not more than 50 parts by weight, and more preferably not more than 45 parts by weight per 100 parts by weight of the base rubber. If the compounding amount is too large, the core may become too hard, giving the ball an unpleasant feel at impact, and if the compounding amount is too small, rebound may become low.

As a filler, for example, zinc oxide, barium sulfate, calcium carbonate, or the like may be suitably used. These may be used singly, or two or more may be used in combination. The compounding amount of the filler is preferably 1 part by weight or more, and more preferably 3 parts by weight or more per 100 parts by weight of the base rubber. In addition, an upper limit of the compounding amount is preferably 50 parts by weight or less, more preferably 40 parts by weight or less, and even more preferably 30 parts by weight or less per 100 parts by weight of the base rubber. If the compounding amount is too large or too small, it may not be possible to obtain an appropriate weight and a suitable rebound.

As an antioxidant, for example, commercially available products such as Nocrac NS-6, Nocrac NS-30, Nocrac NS-200, and Nocrac MB (all manufactured by Ouchi Shinko Chemical Industrial Co., Ltd.) may be employed. These may be used singly, or two or more may be used in combination.

The compounding amount of the antioxidant is not particularly limited, but is preferably 0.05 parts by weight or more, and more preferably 0.1 part by weight or more, and the upper limit is preferably 1.0 part by weight or less, more preferably 0.7 part by weight or less, and even more preferably 0.5 part by weight or less per 100 parts by weight of the base rubber. If the compounding amount is too large or too small, a suitable core hardness gradient cannot be obtained, and it may not be possible to obtain suitable rebound, durability, and a spin rate-lowering effect on full shots.

The core can be manufactured by vulcanizing and curing the rubber composition containing the above components. For example, a molded body can be manufactured by intensively mixing the rubber composition using a mixing apparatus such as a Banbury mixer or a roll mill, subsequently compression molding or injection molding the mixture using a core mold, and curing the resulting molded body by appropriately heating it at a temperature sufficient for the organic peroxide or the co-crosslinking agent to act, such as at a temperature of 100 to 200° C., and preferably at a temperature of 140 to 180° C., for 10 to 40 minutes.

Next, the surrounding layer is described.

The surrounding layer has a material hardness on the Shore D hardness scale which, although not particularly limited, is preferably at least 47, more preferably at least 49, and still more preferably at least 51, and the upper limit value is preferably not more than 62, more preferably not more than 60, and still more preferably not more than 58. The material hardness on the Shore C hardness scale is preferably at least 72, more preferably at least 75, and still more preferably at least 78, and the upper limit value is preferably not more than 93, more preferably not more than 91, and still more preferably not more than 89. If the material hardness of the surrounding layer is too soft, the spin rate may increase on full shots, or an initial velocity may decrease and the intended distance may not be increased. On the other hand, if the material hardness is too hard, the feel at impact may become hard, and the durability to cracking on repeated impact may worsen. Furthermore, the spin rate on full shots may increase excessively.

A surface hardness of a surrounding layer-encased sphere in which the core is encased with the surrounding layer is not particularly limited, although the surface hardness is preferably at least 53, more preferably at least 55, and still more preferably at least 57 on the Shore D hardness scale, and the upper limit value is preferably not more than 68, more preferably not more than 66, and still more preferably not more than 64. The surface hardness on the Shore C hardness scale is preferably at least 80, more preferably at least 83, and still more preferably at least 86, and the upper limit value is preferably not more than 97, more preferably not more than 96, and still more preferably not more than 95. If the surface hardness of the surrounding layer-encased sphere is too soft, the spin rate may increase on full shots, or the initial velocity may decrease and the intended distance may not be increased. On the other hand, if the surface hardness of the surrounding layer-encased sphere is too hard, the feel at impact may become hard, and the durability to cracking on repeated impact may worsen. Furthermore, the spin rate on full shots may increase excessively.

If the surrounding layer is formed in a plurality of layers, the above-mentioned material hardness means a material hardness of an outer surrounding layer, and the above-mentioned surface hardness means a surface hardness of an outer surrounding layer-encased sphere.

A thickness of the surrounding layer is preferably at least 0.8 mm, more preferably at least 1.0 mm, and still more preferably at least 1.2 mm. On the other hand, the upper limit value of the thickness of the surrounding layer is preferably not more than 2.0 mm, more preferably not more than 1.6 mm, and still more preferably not more than 1.4 mm. If the thickness deviates from the above numerical range, the spin rate-lowering effect on full shots is insufficient, so that the intended distance may not be increased on shots with a driver (W #1) and on full shots with an iron. If the thickness of the surrounding layer is too thin, the durability to cracking on repeated impact may worsen. The surrounding layer is preferably formed to be thicker than the intermediate layer to be described later because it is easy to achieve a low spin rate on full shots.

The material of the surrounding layer is made of a resin material from the viewpoint of securing excellent durability to repeated impact, and in particular, various thermoplastic resin materials may be suitably used. Examples of the resin material of the surrounding layer that may be used include an ionomer resin,
and a resin composition that is a blend of:
a base resin (A) that is a blend of the following components:
(a-1) an olefin-unsaturated carboxylic acid binary random copolymer and/or a metal ion neutralized product of an olefin-unsaturated carboxylic acid binary random copolymer, and
(a-2) an olefin-unsaturated carboxylic acid-unsaturated carboxylic acid ester ternary random copolymer and/or a metal ion neutralized product of an olefin-unsaturated carboxylic acid-unsaturated carboxylic acid ester ternary random copolymer
at a weight ratio of 100:0 to 0:100,
and a non-ionomer thermoplastic elastomer (B) at a weight ratio of 100:0 to 0:100.

Further, a resin composition composed of the components (A) and (B) that blends:
(C) 5 to 120 parts by weight per 100 parts by weight of the resin component of a fatty acid having a molecular weight of from 228 to 1,500 and/or a derivative thereof, and (D) 0.1 to 17 parts by weight per 100 parts by weight of the resin component of a basic inorganic metal compound capable of neutralizing unneutralized acid groups in the components (A) and (C),
is preferably adopted.

As the components (A) to (D), for example, components (A) to (D) of a resin material of an intermediate layer described in JP-A 2010-253268 may be suitably adopted. A resin material having these components is generally a material called a highly neutralized ionomer, and examples of commercially available products thereof include “HPF 1000” and “HPF 2000”, trade names of Dow Chemical Company.

Examples of the non-ionomer thermoplastic elastomer include polyolefin-based elastomers (polyolefin, metallocene polyolefin), polystyrene-based elastomers, diene-based polymers, polyacrylate-based polymers, polyamide-based elastomers, polyurethane-based elastomers, polyester-based elastomers, and polyacetals, and particularly include thermoplastic polyether ester elastomers such as thermoplastic polyether ester elastomers.

Any additive may be appropriately blended in the resin material according to the application. For example, various additives such as a pigment, a dispersant, an antioxidant, an ultraviolet absorber, and a light stabilizer may be included.

An inorganic particulate filler may be blended in the surrounding layer material. The inorganic particulate filler is a component that adjusts a specific gravity and is blended as a reinforcing agent, and is not particularly limited, although zinc oxide, barium sulfate, titanium dioxide, and the like may be appropriately used. Barium sulfate is preferable, and precipitated barium sulfate is still more preferable, since an effect of improving the durability to cracking on repeated impact is large.

A mean particle size of the inorganic particulate filler is not particularly limited, although the mean particle size may be preferably from 0.01 to 100 μm, and more preferably from 0.1 to 10 μm. If the mean particle size of the inorganic particulate filler is too small or too large, dispersibility during material preparation may worsen. The mean particle size means a particle size measured by dispersing the particles in an aqueous solution together with an appropriate dispersant and measuring the particles with a particle size distribution measuring device.

A compounding amount of the inorganic particulate filler is typically more than 0 parts by weight, preferably at least 10 parts by weight, and still more preferably at least 15 parts by weight per 100 parts by weight of the base resin of the surrounding layer material, and the upper limit value is preferably not more than 45 parts by weight, more preferably not more than 35 parts by weight, and still more preferably not more than 25 parts by weight. If this compounding amount is too small, the durability to cracking on repeated impact may worsen. On the other hand, if the compounding amount is too large, the rebound of the ball may be lowered, the spin rate on full shots may be increased, and the intended distance may not be increased.

The surrounding layer material has a specific gravity which, although not particularly limited, is preferably at least 1.05, more preferably at least 1.07, and still more preferably at least 1.09. The upper limit is preferably not more than 1.25, more preferably not more than 1.20, and still more preferably not more than 1.15. If the specific gravity of the surrounding layer is too small, the durability to cracking on repeated impact may worsen. On the other hand, if the specific gravity of the surrounding layer is too large, the compounding amount of the inorganic particulate filler to be blended in the resin material tends to increase, and as a result, the rebound of the ball may be lowered, the spin rate on full shots may increase, and the intended distance may not be increased.

Next, the intermediate layer is described.

The intermediate layer has a material hardness on the Shore D hardness scale which, although not particularly limited, is preferably at least 64, more preferably at least 65, and still more preferably at least 66, and the upper limit value is preferably not more than 75, more preferably not more than 72, and still more preferably not more than 70. The material hardness on the Shore C hardness scale is preferably at least 90, more preferably at least 92, and still more preferably at least 94, and the upper limit value is preferably not more than 100, more preferably not more than 98, and still more preferably not more than 96. If the material hardness of the intermediate layer is too soft, the ball may be too receptive to spin on full shots, the initial velocity may be lowered, and the intended distance may not be increased on shots with a driver (W #1) and an iron. On the other hand, if the material hardness of the intermediate layer is too hard, the durability to cracking on repeated impact may worsen, and the feel at impact on shots with a putter or on short approaches may be too hard.

A surface hardness of the intermediate layer-encased sphere obtained by encasing the surrounding layer-encased sphere with the intermediate layer is not particularly limited, although the surface hardness is preferably at least 68, more preferably at least 69, and still more preferably at least 70 in Shore D hardness, and the upper limit value is preferably not more than 78, more preferably not more than 75, and still more preferably not more than 72. The surface hardness on the Shore C hardness scale is preferably at least 95, more preferably at least 96, and still more preferably at least 97, and the upper limit value is preferably not more than 100, more preferably not more than 99, and still more preferably not more than 98. If the surface hardness of the intermediate layer-encased sphere is too soft, the ball may be too receptive to spin on full shots, the initial velocity may be lowered, and the intended distance may not be increased on shots with a driver (W #1) and an iron. On the other hand, if the surface hardness of the intermediate layer-encased sphere is too hard, the durability to cracking on repeated impact may worsen, and the feel at impact on shots with a putter or on short approaches may become too hard.

The intermediate layer has a thickness which is preferably at least 0.7 mm, more preferably at least 0.8 mm, and still more preferably at least 1.0 mm. On the other hand, the intermediate layer thickness has an upper limit value that is preferably not more than 1.6 mm, more preferably not more than 1.4 mm, and still more preferably not more than 1.2 mm. If the thickness of the intermediate layer deviates from the above numerical range or becomes thinner than the thickness of the cover to be described later, the spin rate-lowering effect may become insufficient, and the intended distance may not be increased on shots with a driver (W #1) and an iron. If the thickness of the intermediate layer is too thin, the durability to cracking on repeated impact may worsen.

As the material of the intermediate layer, various thermoplastic resins used as a golf ball material, and particularly a resin material chiefly composed of an ionomer resin, may be adopted.

The ionomer resin material preferably contains an ionomer having a high acid content. For example, it is preferable to blend a high-acid ionomer resin having an acid content of at least 16 wt % among commercially available ionomer resins with an ordinary ionomer resin. With this blending, it is possible to secure the intended distance by achieving both a low spin rate and high rebound on full shots with a driver (W #1).

A proportion of the high-acid ionomer resin in the resin material is preferably at least 20 wt %, more preferably at least 50 wt %, and still more preferably at least 60 wt % per 100 wt % of the resin material, and the upper limit value is not more than 100 wt %, preferably not more than 90 wt %, and more preferably not more than 85 wt %. If the compounding amount of the high-acid ionomer resin is too small, the spin rate on full shots may increase, the initial velocity may decrease, and the intended distance may not be increased on full shots. On the other hand, when the content of this high-acid ionomer resin is too high, the durability to repeated impact may worsen.

In addition, if an ionomer resin is employed as the base resin, an aspect that uses in admixture a zinc-neutralized ionomer resin and a sodium-neutralized ionomer resin as the base resin is desirable. The blending ratio in terms of zinc-neutralized ionomer resin/sodium-neutralized ionomer resin (weight ratio) is from 5/95 to 95/5, preferably from 10/90 to 90/10, and more preferably from 15/85 to 85/15. If the zinc-neutralized ionomer and the sodium-neutralized ionomer are not included in this ratio, the rebound may become too low to obtain a desired flight on full shots, the durability to cracking on repeated impact at room temperature may worsen, and the durability to cracking at a low temperature (below zero) may worsen.

An inorganic particulate filler may be blended in the intermediate layer material. The inorganic particulate filler is a component that adjusts a specific gravity and is blended as a reinforcing agent, and is not particularly limited, although zinc oxide, barium sulfate, titanium dioxide, and the like may be appropriately used. Barium sulfate is preferable, and precipitated barium sulfate is still more preferable, since an effect of improving the durability to cracking on repeated impact is large.

A mean particle size of the inorganic particulate filler is not particularly limited, although the mean particle size may be preferably from 0.01 to 100 μm, and more preferably from 0.1 to 10 μm. If the mean particle size of the inorganic particulate filler is too small or too large, dispersibility during material preparation may worsen. The mean particle size means a particle size measured by dispersing the particles in an aqueous solution together with an appropriate dispersant and measuring the particles with a particle size distribution measuring device.

The compounding amount of the inorganic particulate filler is typically more than 0 parts by weight, preferably at least 10 parts by weight, and more preferably at least 15 parts by weight per 100 parts by weight of the base resin of the intermediate layer material, and the upper limit is typically not more than 50 parts by weight, preferably not more than 40 parts by weight, and more preferably not more than 30 parts by weight per 100 parts by weight of the base resin of the intermediate layer material. If this compounding amount is too small, the durability to cracking on repeated impact may worsen. On the other hand, if the compounding amount is too large, the rebound of the ball may be lowered, the spin rate on full shots may be increased, and the intended distance may not be increased.

The intermediate layer material has a specific gravity which, although not particularly limited, is preferably at least 1.05, more preferably at least 1.07, and still more preferably at least 1.09. The upper limit is preferably not more than 1.25, more preferably not more than 1.20, and still more preferably not more than 1.15. If the specific gravity of the intermediate layer is too small, the durability to cracking on repeated impact may worsen. On the other hand, if the specific gravity of the intermediate layer is too large, the compounding amount of the inorganic particulate filler to be blended in the resin material tends to increase, and as a result, the rebound of the ball may be lowered, the spin rate on full shots may increase, and the intended distance may not be increased.

In the intermediate layer material, an optional additive may be appropriately included depending on the intended use. For example, various additives such as a pigment, a dispersant, an antioxidant, an ultraviolet absorber, and a light stabilizer can be included. If these additives are included, the compounding amount thereof is preferably 0.1 parts by weight or more, and more preferably 0.5 parts by weight or more, and an upper limit thereof is preferably 10 parts by weight or less, and more preferably 4 parts by weight or less per 100 parts by weight of the base resin.

For the intermediate layer material, it is suitable to abrade the surface of the intermediate layer in order to increase the degree of adhesion to a polyurethane suitably used in a cover material described later. Further, it is preferable that a primer (adhesive agent) is applied to the surface of the intermediate layer after the abrasion treatment, or an adhesion reinforcing agent is added to the intermediate layer material.

Next, the cover is described.

The cover has a material hardness on the Shore D hardness scale which, although not particularly limited, is preferably at least 35, more preferably at least 40, and still more preferably at least 43, and the upper limit value is preferably not more than 53, more preferably not more than 50, and still more preferably not more than 47. The material hardness on the Shore C hardness scale is preferably at least 57, more preferably at least 63, and still more preferably at least 67, and the upper limit value is preferably not more than 80, more preferably not more than 76, and still more preferably not more than 72. If the material hardness of the cover is too soft, the spin rate increases on full shots, and the intended distance may not be increased on shots with a driver (W #1) and an iron. On the other hand, if the material hardness of the cover is too hard, the ball may not be receptive to spin on approach shots, and a scuff resistance may worsen.

A surface hardness of an encased sphere obtained by encasing the intermediate layer-encased sphere with the cover, that is, the ball, is not particularly limited, although the surface hardness is preferably at least 50, more preferably at least 53, and still more preferably at least 56 on the Shore D hardness scale, and the upper limit value is preferably not more than 70, more preferably not more than 65, and still more preferably not more than 61. The surface hardness on the Shore C hardness scale is preferably at least 73, more preferably at least 78, and still more preferably at least 83, and the upper limit value is preferably not more than 95, more preferably not more than 92, and still more preferably not more than 90. If the surface hardness of the ball is too soft, the spin rate increases on full shots, and the intended distance may not be increased on shots with a driver (W #1) and an iron. On the other hand, if the surface hardness of the ball is too hard, the ball may not be receptive to spin on approach shots, and the scuff resistance may worsen.

The cover has a thickness of preferably at least 0.3 mm, more preferably at least 0.5 mm, and still more preferably at least 0.6 mm. On the other hand, the upper limit value in the cover thickness is preferably not more than 1.2 mm, more preferably not more than 0.9 mm, and still more preferably not more than 0.85 mm. If the cover is too thick, the rebound may be lowered or the spin rate may be increased on full shots, and the intended distance may not be increased. On the other hand, if the cover is too thin, the scuff resistance may worsen, and the ball may not be receptive to spin on approach shots and may thus lack sufficient controllability in the short game.

As a material of the cover, various thermoplastic resins used as a cover material of golf balls may be used, but from the viewpoints of spin controllability and mass productivity, it is preferable to use a resin composition containing a polyurethane resin or an ionomer resin as a chief material. Among these materials, it is preferable to use a resin material mainly composed of thermoplastic polyurethane from the viewpoints of excellent scuff resistance and mass productivity.

Specific examples of the resin material principally composed of a thermoplastic polyurethane include resin blends containing a thermoplastic polyurethane (I) and a polyisocyanate compound (II) as principal components.

Describing the thermoplastic polyurethane (I), the construction of the thermoplastic polyurethane includes a soft segment composed of a polymeric polyol (polymeric glycol), which is a long-chain polyol, and a hard segment composed of a chain extender and a polyisocyanate compound. Here, as the long-chain polyol serving as a starting material, any of those hitherto used in the art related to thermoplastic polyurethane may be used, and are not particularly limited, and examples thereof can include polyester polyol, polyether polyol, polycarbonate polyol, polyester polycarbonate polyol, polyolefin polyol, conjugated diene polymer-based polyol, castor oil-based polyol, silicone-based polyol, and vinyl polymer-based polyol. These long-chain polyols may be used singly, or two or more may be used in combination. Among them, a polyether polyol is preferable from the viewpoint that a thermoplastic polyurethane having a high rebound resilience and excellent low-temperature properties can be synthesized.

Examples of the polyether polyol include poly(ethylene glycol), poly(propylene glycol), poly (tetramethylene glycol), and poly(methyltetramethylene glycol) obtained by ring-opening polymerization of a cyclic ether. One kind of polyether polyol may be used, or two or more kinds of polyether polyol may be used in combination. Among these polyether polyols, poly (tetramethylene glycol) and/or poly(methyltetramethylene glycol) are preferred.

A numerical average molecular weight of these long-chain polyols is preferably within a range of from 1,500 to 5,000. By using a long-chain polyol having such a numerical average molecular weight, it is possible to reliably obtain a golf ball made of a thermoplastic polyurethane composition excellent in various properties such as productivity and the above-mentioned rebound. The numerical average molecular weight of the long-chain polyol is more preferably within a range of from 1,700 to 4,000, and still more preferably within a range of from 1,900 to 3,000.

The numerical average molecular weight of the long-chain polyol is a numerical average molecular weight calculated based on a hydroxyl value measured in accordance with JIS K 1557.

As the chain extender, those hitherto used in the art related to thermoplastic polyurethanes can be suitably used, and for example, a low-molecular-weight compound having on the molecule two or more active hydrogen atoms capable of reacting with an isocyanate group and having a molecular weight of 400 or less is preferable. Examples of the chain extender include, but are not limited to, 1,4-butylene glycol, 1,2-ethylene glycol, 1,3-butanediol, 1,6-hexanediol, 2,2-dimethyl-1,3-propanediol, or the like. Among them, the chain extender is preferably an aliphatic diol having from 2 to 12 carbon atoms, and is more preferably 1,4-butylene glycol.

As the polyisocyanate compound, those hitherto used in the art related to thermoplastic polyurethane can be suitably used, and are not particularly limited. Specifically, one or more selected from a group consisting of 4,4′-diphenylmethane diisocyanate, 2,4-toluene diisocyanate (or) 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, and dimer acid diisocyanate may be used. However, it may be difficult to control a crosslinking reaction during injection molding depending on the type of isocyanate. In the present invention, 4,4′-diphenylmethane diisocyanate, which is an aromatic diisocyanate, is most preferable from the viewpoint of providing a balance between stability during production and physical properties to be manifested.

Although not particularly limited, the most preferable thermoplastic polyurethane as the component (I) is a thermoplastic polyurethane synthesized using a polyether polyol as the long-chain polyol, an aliphatic diol as the chain extender, and an aromatic diisocyanate as the polyisocyanate compound, in which the polyether polyol is polytetramethylene glycol having a numerical average molecular weight of at least 1,900, the chain extender is 1,4-butylene glycol, and the aromatic diisocyanate is 4,4′-diphenylmethane diisocyanate.

A blending ratio of active hydrogen atoms:isocyanate groups in the polyurethane forming reaction may be adjusted within a preferable range so that a golf ball composed of a thermoplastic polyurethane composition more excellent in various properties such as rebound, spin performance, scuff resistance, and productivity may be obtained. Specifically, when the above-described long-chain polyol, the polyisocyanate compound, and the chain extender are reacted to manufacture the thermoplastic polyurethane, it is preferable to use each component at such a ratio that the isocyanate group contained in the polyisocyanate compound is from 0.95 to 1.05 mol, based on 1 mol of active hydrogen atoms of the long-chain polyol and the chain extender.

A method for manufacturing the thermoplastic polyurethane as the component (I) is not particularly limited, and the thermoplastic polyurethane may be manufactured by either a prepolymer method or a one-shot method using the long-chain polyol, the chain extender, and the polyisocyanate compound by utilizing a known urethanization reaction. Among these methods, it is preferable to perform melt polymerization substantially in the absence of a solvent, and it is particularly preferable to manufacture the thermoplastic polyurethane by continuous melt polymerization using a multi-screw extruder.

As specific examples of the thermoplastic polyurethane as the component (I), commercially available products may be used such as Pandex T-8295, Pandex T-8290, Pandex T-8260, and Pandex T-8295 (all manufactured by DIC Covestro Polymer, Ltd.).

Next, in a single resin blend including the component (I) and the component (II), at least a part of the polyisocyanate compound used as the component (II) needs to be in a state in which all isocyanate groups in one molecule remain in an unreacted state. That is, a polyisocyanate compound in which all isocyanate groups in one molecule are completely free may be present in a single resin blend, and such a polyisocyanate compound and a polyisocyanate compound in which some isocyanate groups in one molecule are free may coexist.

Although not particularly limited, various isocyanates may be used in the polyisocyanate compound, and specifically, one or more selected from a group consisting of 4,4′-diphenylmethane diisocyanate, 2,4-toluene diisocyanate (or) 2,6-toluene diisocyanate, p-phenylene diisocyanate, xylylene diisocyanate, naphthylene 1,5-diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, and dimer acid diisocyanate may be used. It is preferable to employ 4,4′-diphenylmethane diisocyanate, dicyclohexylmethane diisocyanate, and isophorone diisocyanate among the above group of isocyanates from the viewpoint of a balance between an influence on moldability due to an increase in viscosity associated with a reaction of the thermoplastic polyurethane of the component (A) and physical properties of the resulting golf ball cover material.

Although not an essential component, a thermoplastic elastomer other than the thermoplastic polyurethane may be included as a component (III) with the components (I) and (II). By including the component (III) in the resin blend, the flowability of the resin blend may be further improved, and various physical properties required of the golf ball cover material can be increased, such as rebound and scuff resistance.

As the component (III), specifically, one or more selected from a polyester elastomer, a polyamide elastomer, an ionomer resin, a styrene block elastomer, a hydrogenated styrene butadiene rubber, a styrene-ethylene-butylene-ethylene block copolymer or a modified product thereof, an ethylene-ethylene-butylene-ethylene block copolymer or a modified product of an ethylene-ethylene-butylene-ethylene block copolymer, a styrene-ethylene-butylene-styrene block copolymer or a modified product of a styrene-ethylene-butylene-styrene block copolymer, an ABS resin, polyacetal, polyethylene, and a nylon resin may be used as the thermoplastic elastomer other than the thermoplastic polyurethane. In particular, it is preferable to employ a polyester elastomer, a polyamide elastomer, and a polyacetal for the reason that rebound and scuff resistance are improved while productivity is well maintained.

Although a compositional ratio of the components (I), (II), and (III) is not particularly limited, in order to sufficiently and effectively exhibit advantageous effects of the present invention, a compositional ratio (I):(II):(III) is preferably in the weight ratio range of 100:2 to 50:0 to 50, and still more preferably 100:2 to 30:8 to 50.

Although a method for mixing the above components (I) to (III) to prepare a resin blend is not particularly limited, it is preferable to select conditions under which the polyisocyanate compound in which all isocyanate groups remain in an unreacted state is present in at least a part of the polyisocyanate compound. Specifically, it is desirable to take measures such as mixing the above components with an inert gas such as nitrogen gas or in a vacuum state. This resin blend is then injection molded around a core disposed in a mold, and is preferably formed into a pellet shape having a length of 1 to 10 mm and a diameter of 0.5 to 5 mm for the reason of smoothly and easily handling the resin blend. An unreacted isocyanate group remains in the resin pellet, and the unreacted isocyanate group reacts with the component (A) and the component (III) to form a crosslinked product during injection molding in the core or by a post-treatment such as subsequent annealing.

Furthermore, various additives other than the components constituting the thermoplastic polyurethane can be included in the resin blend as necessary, and for example, a pigment, a dispersant, an antioxidant, a light stabilizer, an ultraviolet absorber, an internal mold lubricant, or the like can be appropriately included.

The cover has a specific gravity which, although not particularly limited, is preferably at least 1.05, more preferably at least 1.08, and still more preferably at least 1.10. The upper limit is preferably not more than 1.20, more preferably not more than 1.17, and still more preferably not more than 1.14. If the specific gravity of the cover is too small, a cover resin of a different material such as an ionomer is blended with a urethane, and the scuff resistance and durability to repeated impact may worsen. On the other hand, if the specific gravity of the cover is too large, a filler is added to the urethane, and as a result, the rebound of the ball is lowered, and the intended distance may not be attainable on full shots.

The manufacture of a multi-piece solid golf ball in which the above-described core, surrounding layer, intermediate layer, and cover (outermost layer) are formed as successive layers may be performed by a customary method such as a known injection molding process. For example, each material of the surrounding layer and the intermediate layer is sequentially injected around the core with each injection mold to obtain each layer-encased sphere, and finally, a cover material, which is the outermost layer, is injection molded to obtain a multi-piece golf ball. In addition, as each encasing layer, it is also possible to produce the golf ball by preparing two half-cups pre-molded into hemispherical shapes, enclosing the layer-encased sphere within the two half-cups, and molding the encased spheres under applied heat and pressure.

The deflection (mm) when the golf ball is compressed under a final load of 1,275 N (130 kgf) from an initial load of 98 N (10 kgf) is preferably at least 2.00 mm, more preferably at least 2.15 mm, and still more preferably at least 2.25 mm, and an upper limit value is preferably not more than 3.30 mm, more preferably not more than 2.85 mm, and still more preferably not more than 2.65 mm. If the deflection of the golf ball is too small, that is, if the golf ball is too hard, the spin rate may increase on full shots, the intended distance may not be increased on shots with a driver (W #1) and on full shots with an iron, and the feel at impact may become too hard. On the other hand, if the deflection is too large, that is, if the golf ball is too soft, the actual initial velocity on full shots may become low, and in particular, the intended distance may not be increased on shots with a driver (W #1) at a high head speed of at least HS 45 m/s. In addition, the feel at impact may be too soft, and the durability to cracking on repeated impact may worsen.

### [Relationship Between Deflection of Core and Ball]

Letting the deflection when the core is compressed under a final load of 1,275 N (130 kgf) from an initial load of 98 N (10 kgf) be A (mm), and the deflection when the golf ball is compressed under a final load of 1,275 N (130 kgf) from an initial load of 98 N (10 kgf) be B (mm), a value of A-B is preferably at least 1.00 mm, more preferably at least 1.10 mm, and still more preferably at least 1.20 mm, and the upper limit value is preferably not more than 1.50 mm, more preferably not more than 1.45 mm, and still more preferably not more than 1.42 mm. If this value is too large, the actual initial velocity on shots with a driver (W #1) may become low, the intended distance may not be attainable, and the durability to cracking on repeated impact may worsen. On the other hand, if this value is too small, the feel at impact on full shots may feel hard, and the durability to cracking on repeated impact may worsen.

A ratio of the deflection of the core to the deflection of the ball, that is, a value of A/B, is preferably at least 1.45, more preferably at least 1.47, and still more preferably at least 1.50, and the upper limit value is preferably not more than 1.65, more preferably not more than 1.60, and still more preferably not more than 1.55. If this value is too large, the actual initial velocity on shots with a driver (W #1) may become low, the intended distance may not be attainable, and the durability to cracking on repeated impact may worsen. On the other hand, if this value is too small, the feel at impact on full shots may feel hard, and the durability to cracking on repeated impact may worsen.

### [Hardness Relationships of Layers]

Expressed on the Shore D hardness scale, a value obtained by subtracting the surface hardness of the ball from the surface hardness of the intermediate layer-encased sphere is preferably at least 1, more preferably at least 5, and still more preferably at least 8, and an upper limit value is preferably not more than 16, more preferably not more than 14, and still more preferably not more than 12. If the above value is too small, the spin rate on approach shots is reduced, and controllability in the short game may worsen. On the other hand, if the above value is too large, in a case where the cause is the intermediate layer, the durability to cracking on repeated impact may worsen. In a case where the cause is the cover, the spin rate on full shots increases, and the intended distance may not be attainable.

Expressed on the Shore D hardness scale, a value obtained by subtracting the surface hardness of the surrounding layer-encased sphere from the surface hardness of the intermediate layer-encased sphere is preferably at least 1, more preferably at least 3, and still more preferably at least 6, and the upper limit value is preferably not more than 15, more preferably not more than 12, and still more preferably not more than 10. If this value falls outside of the above numerical ranges, the spin rate on full shots increases, and the intended distance may not be attainable.

Expressed on the Shore D hardness scale, a value obtained by subtracting the surface hardness of the core from the surface hardness of the surrounding layer-encased sphere is preferably at least 1, more preferably at least 3, and still more preferably at least 4, and the upper limit value is preferably not more than 14, more preferably not more than 10, and still more preferably not more than 8. Expressed on the Shore D hardness scale, a value obtained by subtracting the center hardness of the core from the surface hardness of the surrounding layer-encased sphere is preferably at least 21, more preferably at least 24, and still more preferably at least 27, and the upper limit value is preferably not more than 35, more preferably not more than 33, and still more preferably not more than 31. Expressed on the Shore C hardness scale, a value obtained by subtracting the center hardness of the core from the surface hardness of the intermediate layer-encased sphere is preferably at least 33, more preferably at least 36, and still more preferably at least 38, and an upper limit value is preferably not more than 50, more preferably not more than 47, and still more preferably not more than 44. If these values are too large, the durability to cracking on repeated impact may worsen, and the actual initial velocity on shots with a driver (W #1) may become low, so that the intended distance may not be attainable. On the other hand, if these values become too small, the spin rate on full shots may increase, and in particular, the intended distance may not be attainable on shots with a driver (W #1) at a head speed of not more than 40 m/s and on full shots with an iron.

A hardness relationship of the entire ball preferably satisfies the following condition.

Center hardness of core<surface hardness of core<surface hardness of surrounding layer-encased sphere<surface hardness of intermediate layer-encased sphere>surface hardness of ball (where hardnesses indicate Shore D hardness).

If the above condition is not satisfied, it may be difficult to achieve both a superior distance on full shots and superior controllability in the short game.

### [Thickness Relationships of Layers]

A value obtained by subtracting the intermediate layer thickness from the surrounding layer thickness is preferably at least 0.05 mm, more preferably at least 0.10 mm, and still more preferably at least 0.20 mm, and the upper limit value is preferably not more than 0.60 mm, more preferably not more than 0.50 mm, and still more preferably not more than 0.40 mm. If the above value deviates from the above range, the spin rate on full shots may increase, and in particular, the intended distance may not be increased on shots with a driver (W #1) at a head speed of not more than 40 m/s and on full shots with an iron.

The sum of the thickness of the surrounding layer and the thickness of the intermediate layer is preferably at least 1.8 mm, more preferably at least 2.0 mm, and still more preferably at least 2.2 mm, and the upper limit value is preferably not more than 3.6 mm, more preferably not more than 3.0 mm, and still more preferably not more than 2.5 mm. The value obtained by dividing the above (sum of surrounding layer thickness and intermediate layer thickness) by a diameter of the ball, that is, a value of (surrounding layer thickness+intermediate layer thickness)/ball diameter, is preferably at least 0.042, more preferably at least 0.047, and still more preferably at least 0.052, and the upper limit value is preferably not more than 0.084, more preferably not more than 0.070, and still more preferably not more than 0.059. If the above value deviates from the above range, the spin rate on full shots may increase, and in particular, the intended distance may not be increased on shots with a driver (W #1) at a head speed of not more than 40 m/s and on full shots with an iron. If this value is too small, the durability to cracking on repeated impact may worsen.

The thickness of the intermediate layer is preferably larger than the thickness of the cover. In this case, a value obtained by subtracting the cover thickness from the intermediate layer thickness is preferably at least 0.05 mm, more preferably at least 0.10 mm, and still more preferably at least 0.20 mm, and the upper limit value is preferably not more than 0.60 mm, more preferably not more than 0.50 mm, and still more preferably not more than 0.40 mm. If this value is too large, in a case where the cause is the cover thickness, there may be insufficient spin on approach shots. In addition, in the above case, in a case where the cause is the intermediate layer thickness, the feel at impact may feel hard. On the other hand, if the above value is too small, in a case where the cause is the cover thickness, the rebound of the ball may become low, the spin rate may become large on full shots, and the intended distance may not be attainable. In addition, in a case where the cause is the intermediate layer thickness, the durability to cracking on repeated impact may worsen.

### [Core Diameter and Ball Diameter]

The relationship between the core diameter and the ball diameter, that is, a value of (core diameter)/(ball diameter) is preferably at least 0.823, more preferably at least 0.827, and still more preferably at least 0.829. An upper limit value is preferably not more than 0.890, more preferably not more than 0.881, and still more preferably not more than 0.871. If this value is too small, the initial velocity of the ball may become low, or the deflection of the entire ball becomes small and the ball may become hard, and the spin rate of the ball on full shots rises, so that the intended distance may not be attainable. On the other hand, if the above value is too large, the spin rate of the ball on full shots increases, and in particular, the intended distance may not be increased on shots with a driver (W #1) at a head speed of not more than 40 m/s and on full shots with an iron, or the durability to cracking on repeated impact may worsen.

### [Specific Gravities of Layers]

It is recommended that a difference in the specific gravity of each layer between the specific gravity of the core, the specific gravity of the surrounding layer, the specific gravity of the intermediate layer, and the specific gravity of the cover is preferably within =0.10, and more preferably within +0.05. That is, a value of (specific gravity of core)−(specific gravity of surrounding layer), a value of (specific gravity of core)−(specific gravity of intermediate layer), a value of (specific gravity of core)−(specific gravity of cover), a value of (specific gravity of surrounding layer)−(specific gravity of intermediate layer), a value of (specific gravity of surrounding layer)−(specific gravity of cover), and a value of (specific gravity of intermediate layer)−(specific gravity of cover) are preferably at least −0.10, and more preferably at least −0.05, and the upper limit value is preferably not more than 0.10, and more preferably not more than 0.05. If the difference in specific gravity between the layers is too large, in a case where the surrounding layer, the intermediate layer, or the cover may not be molded completely concentrically with the layers located inside these layers and is eccentric, when the ball is struck with a putter, the ball may greatly wobble to the left or right. In the specific gravity of the core, the specific gravity of the surrounding layer, the specific gravity of the intermediate layer, and the specific gravity of the cover, a difference between the maximum value and the minimum value among the specific gravity differences between these members is preferably not more than ±0.10.

Numerous dimples may be formed on the outside surface of the cover. The number of dimples arranged on the surface of the cover is not particularly limited, but is preferably 250 or more, preferably 300 or more, and more preferably 320 or more, and an upper limit thereof may be preferably 380 or less, more preferably 350 or less, and even more preferably 340 or less. If the number of dimples is larger than the above range, the ball trajectory may become lower, and the distance traveled by the ball may decrease. On the other hand, if the number of dimples decreases, the ball trajectory may become higher, and the distance traveled by the ball may not increase.

As for the shape of the dimples, one type or a combination of two or more types such as a circular shape, various polygonal shapes, a dewdrop shape, and other oval shapes may be appropriately used. For example, if circular dimples are used, the diameter can be about 2.5 mm or more and 6.5 mm or less, and the depth can be 0.08 mm or more and 0.30 mm or less.

A dimple coverage ratio of the dimples on the spherical surface of the golf ball, specifically, a ratio (SR value) of a sum of the individual dimple surface areas, each defined by a flat plane circumscribed by an edge of a dimple, to a ball spherical surface area on the assumption that the ball has no dimples is desirably 70% or more and 90% or less from the viewpoint of sufficiently exhibiting aerodynamic properties. A total volume of the dimples is preferably from 245 to 326 mm³. Furthermore, a value V₀ obtained by dividing the spatial volume of the dimples below the flat plane circumscribed by the edge of each dimple by a volume of a cylinder whose base is the flat plane and whose height is a maximum depth of the dimple from the base is preferably at least 0.35 and not more than 0.80 from the viewpoint of optimizing the ball trajectory. If there is a deviation from the ranges of each numerical value described above, the resulting trajectory may not enable a good distance to be attained, and the ball may fail to travel a sufficiently satisfactory distance.

The golf ball of the present invention may be made to conform to the Rules of Golf for play. The inventive ball may be formed to a diameter which is such that the ball does not pass through a ring having an inner diameter of 42.672 mm and to a weight which is preferably between 45.0 and 45.93 g.

### EXAMPLES

Hereinafter, the present invention is specifically described with reference to Examples and Comparative Examples, but the present invention is not limited to the following Examples.

### Examples 1 to 4 and Comparative Examples 1 to 6

### [Formation of Core]

Rubber compositions of each of Example 3 and Comparative Example 5 shown in Table 1 were prepared, and then vulcanization molding was performed at temperatures and for times shown in Table 1 to produce a solid core.

Rubber compositions of each of Examples 1, 2, and 4 and Comparative Examples 1 to 4 and 6 shown in Table 1 are prepared, and then vulcanization molding is performed at temperatures and for times shown in Table 1 to produce solid cores for each example.

TABLE 1

| | | Example | | | | Comparative Example | | | | | |
|---|---|---|---|---|---|---|---|---|---|---|---|
| | | 1 | 2 | 3 | 4 | 1 | 2 | 3 | 4 | 5 | 6 |
| (A) | Polybutadiene A | 100 | 100 | 100 | 100 | 100 | 100 | 100 | 100 | 100 | |
| (A) | Polybutadiene B | | | | | | | | | | 100 |
| — | Zinc acrylate A | | | | | | | | | | 25.95 |
| — | Zinc acrylate B | 40.1 | 38.1 | 38.1 | 36.1 | 33.5 | 31.5 | 29.5 | 34.7 | 34.7 | |
| — | Zinc stearate | 2.0 | 2.0 | 2.0 | 2.0 | 2.0 | 2.0 | 2.0 | 2.0 | 2.0 | 2.0 |
| (B) | Organic peroxide A | 1.0 | 1.0 | 1.0 | 1.0 | 1.0 | 1.0 | 1.0 | 1.0 | 1.0 | 0.6 |
| (B) | Organic peroxide B | | | | | | | | | | 0.6 |
| (C) | Water | 0.6 | 0.6 | 0.6 | 0.6 | 0.3 | 0.3 | 0.3 | 0.3 | 0.3 | |
| (D) | Sulfur | 0.038 | 0.038 | 0.038 | 0.038 | 0.025 | 0.025 | 0.025 | 0.025 | 0.025 | |
| | | (0.030) | (0.030) | (0.030) | (0.030) | (0.020) | (0.020) | (0.020) | (0.020) | (0.020) | |
| — | Antioxidant A | | | | | 0.1 | 0.1 | 0.1 | 0.1 | 0.1 | 0.2 |
| — | Antioxidant B | 0.3 | 0.3 | 0.3 | 0.3 | | | | | | |
| — | Zinc oxide | 10.7 | 11.6 | 22.3 | 12.4 | 13.5 | 14.4 | 15.2 | 11.6 | 16.7 | 4.0 |
| — | Barium sulfate | | | | | | | | | | 13.9 |
| (E) | Zinc salt of | 0.6 | 0.6 | 0.6 | 0.6 | 0.3 | 0.3 | 0.3 | 0.3 | 0.3 | 0.15 |
| | pentachlorothiophenol | | | | | | | | | | |

| | | | | | | | | | | |
|---|---|---|---|---|---|---|---|---|---|---|
| Vulcanization temperature | 150 | 150 | 150 | 150 | 150 | 150 | 150 | 150 | 150 | 158 |
| (°C) | | | | | | | | | | |
| Vulcanization time (min) | 19 | 19 | 19 | 19 | 19 | 19 | 19 | 19 | 19 | 16 |

*The number in parentheses of component (D) indicates an actual sulfur component amount.
The details of each component described in Table 1 are as follows.
Polybutadiene A: Trade name “BR T700” (manufactured by ENEOS Materials Corporation)
Polybutadiene B: Trade name “BR 01” (manufactured by ENEOS Materials Corporation)
Zinc acrylate A: Trade name “ZN-DA85S” (manufactured by Nippon Shokubai Co., Ltd.)
Zinc acrylate B: Trade name “ZN-DA85SR” (manufactured by Nippon Shokubai Co., Ltd.)
Zinc stearate: Trade name “Zinc Stearate BR-3T” (manufactured by Akrochem Corporation)
Organic peroxide A: Dicumyl peroxide, trade name “Percumyl D” (manufactured by NOF Corporation)
Organic peroxide B: A mixture of 1,1-di(t-butylperoxy)cyclohexane and silica, trade name “Perhexa C-40” (manufactured by NOF Corporation)
Sulfur: Trade name “SANMIX S-80N” (manufactured by Sanshin Chemical Industry Co., Ltd.), sulfur masterbatch containing 80 wt % of sulfur powder for rubber
Water: Pure water (manufactured by Seiki Co., Ltd.)
Antioxidant A: 2,2-methylenebis(4-methyl-6-butylphenol), trade name “Nocrac NS-6” (manufactured by Ouchi Shinko Chemical Industrial Co., Ltd.)
Antioxidant B: 2-mercaptobenzimidazole, trade name “Nocrac MB” (manufactured by Ouchi Shinko Chemical Industrial Co., Ltd.)
Zinc oxide: Trade name “Grade 3 Zinc Oxide” (manufactured by Sakai Chemical Industry Co., Ltd.)
Zinc salt of pentachlorothiophenol: Manufactured by FUJIFILM Wako Pure Chemical Corporation

### [Formation of Surrounding Layer, Intermediate Layer, and Cover (Outermost Layer)]

Next, in Example 3, a resin material No. 1 of a surrounding layer shown in Table 2 was injection-molded around a core surface of each example using an injection mold to obtain a surrounding layer-encased sphere. In Comparative Example 5, the surrounding layer is not formed. Next, in Example 3 and Comparative Example 5, a resin material No. 3 of an intermediate layer shown in Table 2 was injection-molded around the surrounding layer-encased sphere or the core using another injection mold to obtain an intermediate layer-encased sphere. Further, a resin material No. 5 of a cover shown in Table 2 was injection-molded around the intermediate layer-encased sphere using another injection mold to obtain a golf ball. At this time, a large number of predetermined dimples described below were formed on a cover surface.

In Examples 1, 2, and 4 and Comparative Examples 1 to 4 and 6, the resin material No. 1 or No. 2 of the surrounding layer shown in Table 2 is injection-molded around the core surface of each example using an injection mold to obtain a surrounding layer-encased sphere. In Comparative Example 4, the surrounding layer is not formed. Next, using another injection mold, a resin material No. 3 or No. 4 of an intermediate layer shown in Table 2 is injection-molded around the surrounding layer-encased sphere to obtain an intermediate layer-encased sphere. Further, a resin material No. 5 of a cover shown in Table 2 is injection-molded around the intermediate layer-encased sphere to obtain a golf ball. At this time, a plurality of predetermined dimples described below are formed on the cover surface.

TABLE 2

| Resin composition | High-acid | Metal | | | | | |
|---|---|---|---|---|---|---|---|
| (pbw) | ionomer | type | No. 1 | No. 2 | No. 3 | No. 4 | No. 5 |
| HPF1000 | Not applicable | Mg | 100 | 100 | | | |
| Himilan 1706 | Not applicable | Zn | | | 15 | 15 | |
| AM7318 | Applicable | Na | | | 85 | 85 | |
| Titanium oxide | | | | | | | 3.0 |
| Barium sulfate | | | | 18 | | 20 | |
| Magnesium stearate | | | | | | 1.0 | |
| Polyethylene wax | | | | | | 0.002 | 1.2 |
| Trimethylolpropane | | | | | 1.1 | 1.1 | |
| Thermoplastic polyurethane | | | | | | | 100 |
| Polyisocyanate compound | | | | | | | 10.6 |
| Thermoplastic elastomer | | | | | | | 14.5 |
| Additive | | | | | | | 6.5 |

Details of the blending components in Table 2 are as follows.
“HPF 1000” manufactured by Dow Chemical Company
“Himilan 1706” and “AM7318” ionomer resins manufactured by Dow-Mitsui Polychemicals Co., Ltd.
Trade name “Precipitated Barium Sulfate 300” barium sulfate manufactured by Sakai Chemical Industry Co., Ltd.
Trade name “Magnesium stearate G” magnesium stearate manufactured by NOF Corporation
“Trimethylolpropane” manufactured by Tokyo Chemical Industry Co., Ltd.
Trade name “Sun Wax 161-P” polyethylene wax manufactured by Sanyo Chemical Industries, Ltd.
Ether-type thermoplastic polyurethane, trade name “Pandex” manufactured by DIC Covestro Polymer Ltd.
Thermoplastic elastomer, trade name “Hytrel 2401”, polyester elastomer manufactured by Toray Celanese Co., Ltd.
Additives such as blue pigment, titanium oxide, and wax

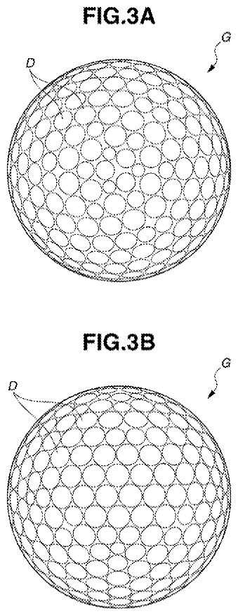

For the dimples of each of the Examples and Comparative Examples, the following common dimple mode is used. This dimple mode includes eight types of circular dimples of No. 1 to No. 8 having different diameters and depths. The details are listed in Table 3 below. In addition, this dimple arrangement mode (pattern) is illustrated in FIGS. 3A and 3B. FIG. 3A is a plan view of the dimples, and FIG. 3B is a side view of the dimples.

TABLE 3

| | | | | | Cylinder | | |
|---|---|---|---|---|---|---|---|
| | | Diameter | Depth | Volume | volume ratio | Total volume | SR |
| Type | Quantity | (mm) | (mm) | (mm³) | Vo | (mm³) | (%) |
| No. 1 | 12 | 4.63 | 0.122 | 1.009 | 0.491 | 278 | 84 |
| No. 2 | 198 | 4.50 | 0.119 | 0.919 | 0.486 | | |
| No. 3 | 36 | 3.92 | 0.115 | 0.655 | 0.472 | | |
| No. 4 | 12 | 2.87 | 0.086 | 0.245 | 0.442 | | |
| No. 5 | 36 | 4.49 | 0.126 | 0.965 | 0.483 | | |
| No. 6 | 24 | 3.92 | 0.124 | 0.711 | 0.473 | | |
| No. 7 | 6 | 3.31 | 0.133 | 0.550 | 0.479 | | |
| No. 8 | 6 | 3.21 | 0.132 | 0.457 | 0.430 | | |
| Total | 330 | | | | | | |

[Definition of Dimple]
Edge: Highest point in cross section passing through the center of the dimple
Diameter: Diameter of the flat plane circumscribed by the edge of the dimple
Depth: Maximum depth of the dimple from the flat plane circumscribed by the edge of the dimple
SR: Ratio of the sum of the individual dimple surface areas, each defined by the flat plane circumscribed by the edge of the dimple, to the ball spherical surface area on the assumption that the ball has no dimples
Dimple volume: Volume of the dimple under the flat plane circumscribed by the edge of the dimple
Total dimple volume: Sum of the dimple volumes of all dimples
Cylinder volume ratio: Ratio of the dimple volume to the volume of a cylinder having the same diameter and the same depth as the dimple

For each resulting golf ball, various physical properties such as internal hardnesses at various positions of the core, outer diameters of the core and each layer-encased sphere, thicknesses and material hardnesses of each layer, and deflections and surface hardnesses of each layer-encased sphere are evaluated by the following methods, and are shown in Tables 4 and 5.

### [Outer Diameters of Each Sphere of Core, Surrounding Layer-Encased Sphere, and Intermediate Layer-Encased Sphere]

After being temperature-adjusted to 23.9±1° C. for at least three hours in a thermostatic bath, the sphere to be measured is measured in a room at a temperature of 23.9±2° C. Five random places on the surface are measured, and using an average value of these measurements as a measured value of each sphere, an average value for the diameter of 10 such spheres is determined.

### [Ball Diameter]

After being temperature-adjusted to 23.9±1° C. for at least three hours in a thermostatic bath, the ball to be measured is measured in a room at a temperature of 23.9±2° C. Fifteen random places on a portion with no dimples are measured, and using an average value of these measurements as a measured value of one ball, an average value for the diameter of 10 such balls is determined.

### [Deflections of Core, Layer-Encased Sphere of Each Layer, and Ball]

A subject spherical object of the core, layer-encased sphere of each layer, or ball is placed on a hard plate, and the deflection when compressed under a final load of 1,275 N (130 kgf) from an initial load of 98 N (10 kgf) is measured. The deflection is a measured value after the temperature is adjusted to 23.9° C. A pressing speed of a head that compresses the subject spherical object is set to 10 mm/s.

### [Core Hardness Profile]

The core surface is spherical, but an indenter of a durometer is set substantially perpendicular to the spherical core surface, and a core surface hardness expressed on the Shore C scale is measured in accordance with ASTM D2240. With respect to the core center and a predetermined position of the core, the core is cut into hemispheres to obtain a flat cross-section, the hardness is measured by perpendicularly pressing the indenter of the durometer against a center portion and the predetermined positions shown in Table 4, and the hardnesses at the center and each position are shown as Shore C hardness values. For the measurement of the hardness, a P2 Automatic Rubber Hardness Tester manufactured by Kobunshi Keiki Co., Ltd. equipped with a Shore C durometer is used. A needle of this hardness tester has a descent speed of 17 mm/s. For the hardness value, a maximum value is read. All measurements are carried out in an environment of 23±2° C. The numerical values in Table 4 are Shore C hardness values.

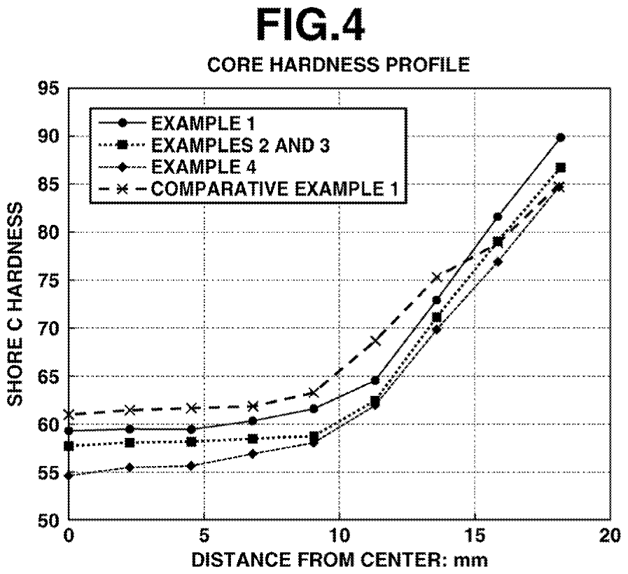

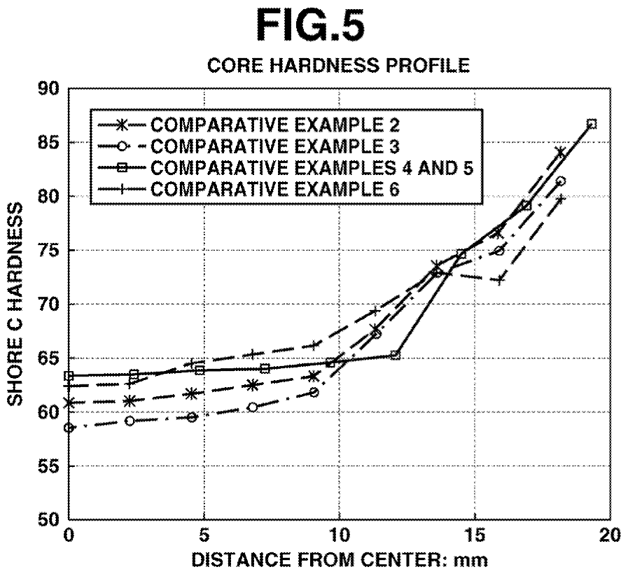

Graphs of core hardness profiles of Examples 1 to 4 and Comparative Examples 1 to 6 are shown in FIGS. 4 and 5.

### [Material Hardnesses of Surrounding Layer, Intermediate Layer, and Cover]

The resin material of each layer is molded into a sheet having a thickness of 2 mm and left for two weeks. Thereafter, the Shore D hardness and the Shore C hardness are measured in accordance with the ASTM D2240 standard. For the measurement of the hardness, the P2 Automatic Rubber Hardness Tester manufactured by Kobunshi Keiki Co., Ltd. is used. A needle of this hardness tester has a descent speed of 17 mm/s. Shore D hardness and Shore C hardness attachments are attached to measure each hardness. For the hardness value, a maximum value is read. All measurements are carried out in an environment of 23±2° C.

### [Surface Hardnesses of Each Layer-Encased Sphere]

A measurement is performed by perpendicularly pressing the indenter against the surface of each sphere. It is noted that a surface hardness of a ball (cover) is a measured value at a dimple-free area (land) on the surface of the ball. The Shore D hardness and the Shore C hardness are measured in accordance with the ASTM D2240 standard. For the measurement of the hardness, the P2 Automatic Rubber Hardness Tester manufactured by Kobunshi Keiki Co., Ltd. is used. A needle of this hardness tester has a descent speed of 17 mm/s. Shore D hardness and Shore C hardness attachments are attached to measure each hardness. For the hardness value, a maximum value is read. All measurements are carried out in an environment of 23±2° C.

TABLE 4-I

| | | Example | | | |
|---|---|---|---|---|---|
| | | 1 | 2 | 3 | 4 |
| Core | Outer diameter (mm) | 36.30 | 36.30 | 36.30 | 36.30 |
| | Weight (g) | 28.52 | 28.52 | 30.04 | 28.53 |
| | Specific gravity (mm) | 1.14 | 1.14 | 1.20 | 1.14 |
| | Deflection (mm) | 3.47 | 3.82 | 3.82 | 4.05 |
| Core | Surface hardness | 60 | 57 | 57 | 56 |
| hardness | Center hardness | 37 | 35 | 35 | 33 |
| profile | Surface − center | 23 | 22 | 22 | 23 |
| (Shore D) | | | | | |
| Core | H100 (surface) | 89.9 | 86.8 | 86.8 | 84.7 |
| hardness | H87.5 | 81.6 | 79.0 | 79.0 | 76.9 |
| profile | H75 | 72.9 | 71.2 | 71.2 | 69.9 |
| (Shore C) | H62.5 | 64.6 | 62.4 | 62.4 | 61.9 |
| | H50 | 61.6 | 58.8 | 58.8 | 58.1 |
| | H37.5 | 60.3 | 58.5 | 58.5 | 56.9 |
| | H25 | 59.5 | 58.2 | 58.2 | 55.6 |
| | H12.5 | 59.5 | 58.1 | 58.1 | 55.5 |
| | H0 (center) | 59.3 | 57.8 | 57.8 | 54.7 |
| | H100 − H87.5 | 8.3 | 7.8 | 7.8 | 7.8 |
| | H87.5 − H75 | 8.7 | 7.8 | 7.8 | 7.0 |
| | H75 − H62.5 | 8.3 | 8.8 | 8.8 | 8.0 |
| | H62.5 − H50 | 3.0 | 3.6 | 3.6 | 3.8 |
| | H50 − H37.5 | 1.3 | 0.3 | 0.3 | 1.2 |
| | H37.5 − H25 | 0.8 | 0.3 | 0.3 | 1.3 |
| | H25 − H12.5 | 0.0 | 0.1 | 0.1 | 0.1 |
| | H12.5 − H0 | 0.2 | 0.3 | 0.3 | 0.8 |
| | H100 − H0 | 30.6 | 29.0 | 29.0 | 30.0 |
| | (surface − center) | | | | |
| | H87.5 − H0 | 22.3 | 21.2 | 21.2 | 22.2 |
| | H100 − H75 | 17.0 | 15.6 | 15.6 | 14.8 |
| | H75 − H50 | 11.3 | 12.4 | 12.4 | 11.8 |
| | H50 − H25 | 2.1 | 0.6 | 0.6 | 2.5 |
| | H25 − H0 | 0.2 | 0.4 | 0.4 | 0.9 |
| | (H100 − H75) − (H75 − H50) | 5.7 | 3.2 | 3.2 | 3.0 |
| | (H75 − H50) − (H50 − H25) | 9.2 | 11.8 | 11.8 | 9.3 |
| | (H50 − H25) − (H25 − H0) | 1.9 | 0.2 | 0.2 | 1.6 |
| | (H87.5 − H50)/(H50 − H12.5) | 9.5 | 28.9 | 28.9 | 7.2 |
| | (H100 − H50)/(H50 − H0) | 12.3 | 28.0 | 28.0 | 7.8 |
| | (H87.5 − H0) × | 77.4 | 81.0 | 81.0 | 89.9 |
| | (core deflection) | | | | |

TABLE 4-II

| | | Comparative Example | | | | | |
|---|---|---|---|---|---|---|---|
| | | 1 | 2 | 3 | 4 | 5 | 6 |
| Core | Outer diameter (mm) | 36.27 | 36.29 | 36.32 | 38.64 | 38.64 | 36.30 |
| | Weight (g) | 28.46 | 28.52 | 28.56 | 34.17 | 35.05 | 28.52 |
| | Specific gravity (mm) | 1.14 | 1.14 | 1.14 | 1.13 | 1.16 | 1.14 |
| | Deflection (mm) | 3.39 | 3.56 | 3.87 | 3.25 | 3.25 | 3.47 |
| Core hardness | Surface hardness | 56 | 54 | 52 | 57 | 57 | 49 |
| profile | Center hardness | 38 | 37 | 36 | 38 | 38 | 35 |
| (Shore D) | Surface − center | 18 | 17 | 16 | 19 | 19 | 14 |
| Core hardness | H100 (surface) | 84.8 | 84.0 | 81.4 | 86.7 | 86.7 | 79.7 |
| profile | H87.5 | 79.0 | 76.6 | 75.0 | 79.1 | 79.1 | 72.2 |
| (Shore C) | H75 | 75.3 | 73.5 | 72.9 | 74.7 | 74.7 | 72.9 |
| | H62.5 | 68.7 | 67.7 | 67.2 | 65.2 | 65.2 | 69.4 |
| | H50 | 63.4 | 63.3 | 61.8 | 64.6 | 64.6 | 66.2 |
| | H37.5 | 61.9 | 62.5 | 60.5 | 64.0 | 64.0 | 65.3 |
| | H25 | 61.7 | 61.7 | 59.5 | 63.9 | 63.9 | 64.5 |
| | H12.5 | 61.5 | 61.1 | 59.2 | 63.4 | 63.4 | 62.6 |
| | H0 (center) | 61.1 | 60.8 | 58.6 | 63.3 | 63.3 | 62.5 |
| | H100 − H87.5 | 5.8 | 7.4 | 6.4 | 7.6 | 7.6 | 7.5 |
| | H87.5 − H75 | 3.7 | 3.1 | 2.1 | 4.4 | 4.4 | −0.7 |
| | H75 − H62.5 | 6.6 | 5.8 | 5.7 | 9.5 | 9.5 | 3.5 |
| | H62.5 − H50 | 5.3 | 4.4 | 5.4 | 0.6 | 0.6 | 3.2 |
| | H50 − H37.5 | 1.5 | 0.8 | 1.3 | 0.6 | 0.6 | 0.9 |
| | H37.5 − H25 | 0.2 | 0.8 | 1.0 | 0.1 | 0.1 | 0.8 |
| | H25 − H12.5 | 0.2 | 0.6 | 0.3 | 0.5 | 0.5 | 1.9 |
| | H12.5 − H0 | 0.4 | 0.3 | 0.6 | 0.1 | 0.1 | 0.1 |
| | H100 − H0 (surface − center) | 23.7 | 23.2 | 22.8 | 23.4 | 23.4 | 17.2 |
| | H87.5 − H0 | 17.9 | 15.8 | 16.4 | 15.8 | 15.8 | 9.7 |
| | H100 − H75 | 9.5 | 10.5 | 8.5 | 12.0 | 12.0 | 6.8 |
| | H75 − H50 | 11.9 | 10.2 | 11.1 | 10.1 | 10.1 | 6.7 |
| | H50 − H25 | 1.7 | 1.6 | 2.3 | 0.7 | 0.7 | 1.7 |
| | H25 − H0 | 0.6 | 0.9 | 0.9 | 0.6 | 0.6 | 2.0 |
| | (H100 − H75) − (H75 − H50) | −2.4 | 0.3 | −2.6 | 1.9 | 1.9 | 0.1 |
| | (H75 − H50) − (H50 − H25) | 10.2 | 8.6 | 8.8 | 9.4 | 9.4 | 5.0 |
| | (H50 − H25) − (H25 − H0) | 1.1 | 0.7 | 1.4 | 0.1 | 0.1 | −0.3 |
| | (H87.5 − H50)/(H50 − H12.5) | 8.2 | 6.0 | 5.1 | 12.1 | 12.1 | 1.7 |
| | (H100 − H50)/(H50 − H0) | 9.3 | 8.3 | 6.1 | 17.0 | 17.0 | 3.6 |
| | (H87.5 − H0) × (core deflection) | 60.7 | 56.2 | 63.5 | 51.4 | 51.4 | 33.7 |

TABLE 5-I

| | | Example | | | |
|---|---|---|---|---|---|
| | | 1 | 2 | 3 | 4 |
| Construction (piece) | | 4P | 4P | 4P | 4P |
| Surrounding layer | Material | No. 2 | No. 2 | No. 1 | No. 2 |
| | Thickness (mm) | 1.31 | 1.31 | 1.31 | 1.29 |
| | Specific gravity | 1.09 | 1.09 | 0.96 | 1.09 |
| | Material hardness (Shore C) | 89 | 89 | 88 | 89 |
| | Material hardness (Shore D) | 58 | 58 | 57 | 58 |
| Surrounding layer-encased sphere | Outer diameter (mm) | 38.91 | 38.91 | 38.91 | 38.88 |
| | Weight (g) | 34.84 | 34.84 | 35.63 | 34.78 |
| | Deflection (mm) | 2.92 | 3.27 | 3.28 | 3.42 |
| | Surface hardness (Shore C) | 95 | 95 | 94 | 95 |
| | Surface hardness (Shore D) | 64 | 64 | 63 | 64 |
| Intermediate layer | Material | No. 4 | No. 4 | No. 3 | No. 4 |
| | Thickness (mm) | 1.07 | 1.07 | 1.07 | 1.07 |
| | Specific gravity | 1.09 | 1.09 | 0.94 | 1.09 |
| | Material hardness (Shore C) | 95 | 95 | 94 | 95 |
| | Material hardness (Shore D) | 67 | 67 | 66 | 67 |
| Intermediate layer-encased sphere | Outer diameter (mm) | 41.04 | 41.04 | 41.04 | 41.02 |
| | Weight (g) | 40.67 | 40.67 | 40.67 | 40.63 |
| | Deflection (mm) | 2.47 | 2.73 | 2.75 | 2.86 |
| | Surface hardness (Shore C) | 98 | 98 | 98 | 98 |
| | Surface hardness (Shore D) | 72 | 72 | 70 | 72 |
| Cover | Material | No. 5 | No. 5 | No. 5 | No. 5 |
| | Thickness (mm) | 0.83 | 0.83 | 0.83 | 0.84 |
| | Specific gravity | 1.12 | 1.12 | 1.12 | 1.12 |
| | Material hardness (Shore C) | 67 | 67 | 67 | 67 |
| | Material hardness (Shore D) | 47 | 47 | 47 | 47 |
| Ball | Outer diameter (mm) | 42.70 | 42.70 | 42.70 | 42.70 |
| | Weight (g) | 45.51 | 45.51 | 45.51 | 45.50 |
| | Deflection (mm) | 2.28 | 2.47 | 2.50 | 2.63 |
| | Surface hardness (Shore C) | 86 | 86 | 85 | 86 |
| | Surface hardness (Shore D) | 61 | 61 | 60 | 61 |

| | | | | |
|---|---|---|---|---|
| Surface hardness of intermediate layer-encased sphere − | 11 | 11 | 10 | 11 |
| ball surface hardness (Shore D) | | | | |
| Surface hardness of intermediate layer-encased sphere − | 8 | 8 | 7 | 8 |
| surface hardness of surrounding layer-encased sphere (Shore D) | | | | |
| Surface hardness of surrounding layer-encased sphere − | 4 | 7 | 6 | 8 |
| core surface hardness (Shore D) | | | | |
| Surface hardness of surrounding layer-encased sphere − | 27 | 29 | 28 | 31 |
| core center hardness (Shore D) | | | | |
| Surface hardness of intermediate layer-encased sphere − | 38.7 | 40.2 | 40.2 | 43.3 |
| core center hardness (Shore C) | | | | |
| Ball surface hardness − core center hardness (Shore C) | 26.7 | 28.2 | 27.2 | 31.3 |
| (Core deflection) − (ball deflection) (mm) | 1.19 | 1.35 | 1.32 | 1.42 |
| (Core deflection)/(ball deflection) | 1.52 | 1.55 | 1.53 | 1.54 |
| Core specific gravity − surrounding layer specific gravity | 0.05 | 0.05 | 0.24 | 0.05 |
| Core specific gravity − intermediate layer specific gravity | 0.05 | 0.05 | 0.26 | 0.05 |
| Core specific gravity − cover specific gravity | 0.02 | 0.02 | 0.08 | 0.02 |
| Surrounding layer specific gravity − intermediate layer specific gravity | 0.00 | 0.00 | 0.02 | 0.00 |
| Surrounding layer specific gravity − cover specific gravity | −0.03 | −0.03 | −0.16 | −0.03 |
| Intermediate layer specific gravity − cover specific gravity | −0.03 | −0.03 | −0.18 | −0.03 |
| Core diameter/ball diameter | 0.850 | 0.850 | 0.850 | 0.850 |
| Intermediate layer thickness + surrounding layer thickness (mm) | 2.37 | 2.37 | 2.37 | 2.36 |
| (Intermediate layer thickness + surrounding layer thickness)/ball diameter | 0.056 | 0.056 | 0.056 | 0.055 |
| Surrounding layer thickness − intermediate layer thickness (mm) | 0.24 | 0.24 | 0.24 | 0.22 |
| Intermediate layer thickness − cover thickness (mm) | 0.23 | 0.23 | 0.23 | 0.23 |

TABLE 5-II

| | | Comparative Example | | | | | |
|---|---|---|---|---|---|---|---|
| | | 1 | 2 | 3 | 4 | 5 | 6 |
| Construction (piece) | | 4P | 4P | 4P | 3P | 3P | 4P |
| Surrounding layer | Material | No. 2 | No. 2 | No. 2 | — | — | No. 2 |
| | Thickness (mm) | 1.33 | 1.30 | 1.29 | — | — | 1.31 |
| | Specific gravity | 1.09 | 1.09 | 1.09 | — | — | 1.09 |
| | Material hardness (Shore C) | 89 | 89 | 89 | — | — | 89 |
| | Material hardness (Shore D) | 58 | 58 | 58 | — | — | 58 |
| Surrounding layer-encased sphere | Outer diameter (mm) | 38.93 | 38.89 | 38.90 | — | — | 38.91 |
| | Weight (g) | 34.90 | 34.81 | 34.81 | — | — | 34.841 |
| | Deflection (mm) | 2.94 | 3.11 | 3.36 | — | — | 2.92 |
| | Surface hardness (Shore C) | 95 | 95 | 95 | — | — | 95 |
| | Surface hardness (Shore D) | 64 | 64 | 64 | — | — | 64 |
| Intermediate layer | Material | No. 4 | No. 4 | No. 4 | No. 4 | No. 3 | No. 4 |
| | Thickness (mm) | 1.06 | 1.08 | 1.07 | 1.21 | 1.21 | 1.07 |
| | Specific gravity | 1.09 | 1.09 | 1.09 | 1.09 | 0.94 | 1.09 |
| | Material hardness (Shore C) | 95 | 95 | 95 | 95 | 94 | 95 |
| | Material hardness (Shore D) | 67 | 67 | 67 | 67 | 66 | 67 |
| Intermediate layer-encased sphere | Outer diameter (mm) | 41.05 | 41.05 | 41.04 | 41.06 | 41.06 | 41.04 |
| | Weight (g) | 40.71 | 40.72 | 40.66 | 40.75 | 40.75 | 40.67 |
| | Deflection (mm) | 2.53 | 2.66 | 2.84 | 2.69 | 2.72 | 2.4 |
| | Surface hardness (Shore C) | 98 | 98 | 98 | 98 | 98 | 98 |
| | Surface hardness (Shore D) | 72 | 72 | 72 | 72 | 70 | 72 |
| Cover | Material | No. 5 | No. 5 | No. 5 | No. 5 | No. 5 | No. 5 |
| | Thickness (mm) | 0.83 | 0.83 | 0.83 | 0.82 | 0.82 | 0.83 |
| | Specific gravity | 1.12 | 1.12 | 1.12 | 1.12 | 1.12 | 1.12 |
| | Material hardness (Shore C) | 67 | 67 | 67 | 67 | 67 | 67 |
| | Material hardness (Shore D) | 47 | 47 | 47 | 47 | 47 | 47 |
| Ball | Outer diameter (mm) | 42.70 | 42.71 | 42.70 | 42.70 | 42.70 | 42.70 |
| | Weight (g) | 45.53 | 45.56 | 45.53 | 45.54 | 45.54 | 45.51 |
| | Deflection (mm) | 2.31 | 2.48 | 2.64 | 2.49 | 2.52 | 2.28 |
| | Surface hardness (Shore C) | 86 | 86 | 86 | 86 | 85 | 86 |
| | Surface hardness (Shore D) | 61 | 61 | 61 | 61 | 60 | 61 |

| | | | | | | |
|---|---|---|---|---|---|---|
| Surface hardness of intermediate layer-encased sphere − | 11 | 11 | 11 | 11 | 10 | 11 |
| ball surface hardness (Shore D) | | | | | | |
| Surface hardness of intermediate layer-encased sphere − | 8 | 8 | 8 | — | — | 8 |
| surface hardness of surrounding layer-encased sphere (Shore D) | | | | | | |
| Surface hardness of surrounding layer-encased sphere − | 8 | 10 | 12 | — | — | 15 |
| core surface hardness (Shore D) | | | | | | |
| Surface hardness of surrounding layer-encased sphere − | 26 | 27 | 28 | — | — | 29 |
| core center hardness (Shore D) | | | | | | |
| Surface hardness of intermediate layer-encased sphere − | 36.9 | 37.2 | 39.4 | 34.7 | 34.7 | 35.5 |
| core center hardness (Shore C) | | | | | | |
| Ball surface hardness − core center hardness (Shore C) | 24.9 | 25.2 | 27.4 | 22.7 | 21.7 | 23.5 |
| (Core deflection) − (ball deflection) (mm) | 1.08 | 1.08 | 1.23 | 0.76 | 0.73 | 1.19 |
| (Core deflection)/(ball deflection) | 1.47 | 1.44 | 1.47 | 1.31 | 1.29 | 1.52 |
| Core specific gravity − surrounding layer specific gravity | 0.05 | 0.05 | 0.05 | — | — | 0.05 |
| Core specific gravity − intermediate layer specific gravity | 0.05 | 0.05 | 0.05 | 0.04 | 0.22 | 0.05 |
| Core specific gravity − cover specific gravity | 0.02 | 0.02 | 0.02 | 0.01 | 0.04 | 0.02 |
| Surrounding layer specific gravity − intermediate layer specific gravity | 0.00 | 0.00 | 0.00 | — | — | 0.00 |
| Surrounding layer specific gravity − cover specific gravity | −0.03 | −0.03 | −0.03 | — | — | −0.03 |
| Intermediate layer specific gravity − cover specific gravity | −0.03 | −0.03 | −0.03 | −0.03 | −0.18 | −0.03 |
| Core diameter/ball diameter | 0.849 | 0.850 | 0.851 | 0.905 | 0.905 | 0.850 |
| Intermediate layer thickness + surrounding layer thickness (mm) | 2.39 | 2.38 | 2.36 | — | — | 2.37 |
| (Intermediate layer thickness + surrounding layer thickness)/ball diameter | 0.056 | 0.056 | 0.055 | — | — | 0.056 |
| Surrounding layer thickness − intermediate layer thickness (mm) | 0.27 | 0.22 | 0.22 | — | — | 0.24 |
| Intermediate layer thickness − cover thickness (mm) | 0.23 | 0.25 | 0.24 | 0.39 | 0.39 | 0.23 |

A flight on shots (W #1) (I #6) and a spin rate on approach shots of each golf ball are evaluated by the following methods. The results are shown in Table 6.

(1) Evaluation of Flight (W #1, HS 54 m/s)

A driver is mounted on a golf swing robot, and the spin rate and distance traveled (total) by a ball when struck at a head speed (HS) of 54 m/s are measured. The club used is a TourB XD-5 Driver/loft angle 8.5° (2017 model) manufactured by Bridgestone Sports Co., Ltd. and is evaluated according to the following rating criteria.

### [Rating Criteria]

Good: Total distance is at least 286.0 m
Fair: Total distance is at least 284.0 m and less than 286.0 m
NG: Total distance is less than 284.0 m
   (2) Evaluation of Flight (W #1, HS 50 m/s)

A driver is mounted on a golf swing robot, and a spin rate and a distance traveled (total) by a ball when struck at a head speed (HS) of 50 m/s are measured. The club used is a TourB XD-5 Driver/loft angle 8.5° (2017 model) manufactured by Bridgestone Sports Co., Ltd. and is evaluated according to the following rating criteria.

### [Rating Criteria]

Good: Total distance is at least 269.0 m
Fair: Total distance is at least 267.0 m and less than 269.0 m
NG: Total distance is less than 267.0 m
   (3) Evaluation of Flight (W #1, HS 45 m/s)

A driver is mounted on the golf swing robot, and the spin rate and the distance traveled (total) by a ball when struck at a head speed (HS) of 45 m/s are measured. The club used is a J015 Driver/loft angle 9.5° (2016 model) manufactured by Bridgestone Sports Co., Ltd. and is evaluated according to the following rating criteria.

### [Rating Criteria]

Good: Total distance is at least 227.0 m
Fair: Total distance is at least 225.0 m and less than 227.0 m
NG: Total distance is less than 225.0 m
   (4) Evaluation of Flight (W #1, HS 40 m/s)

A driver is mounted on the golf swing robot, and the spin rate and the distance traveled (total) by a ball when struck at a head speed (HS) of 40 m/s are measured. The club used is a J015 Driver/loft angle 9.5° (2016 model) manufactured by Bridgestone Sports Co., Ltd. and is evaluated according to the following rating criteria.

### [Rating Criteria]

Good: Total distance is at least 192.0 m
Fair: Total distance is at least 190.0 m and less than 192.0 m
NG: Total distance is less than 190.0 m
   (5) Evaluation of Flight (I #6, HS 42 m/s)

A number six iron (I #6) is mounted on the golf swing robot, and the spin rate and the distance traveled (total) by a ball when struck at a head speed (HS) of 42 m/s are measured. The club used is a JGR Forged I #6 (2016 model) manufactured by Bridgestone Sports Co., Ltd. and is evaluated according to the following rating criteria.

### [Rating Criteria]

Good: Total distance is at least 180.0 m
Fair: Total distance is at least 179.0 m and less than 180.0 m
NG: Total distance is less than 179.0 m
   (6) Evaluation of Flight (I #6, HS 35 m/s)

The number six iron (I #6) is mounted on the golf swing robot and the spin rate and the distance traveled (total) by a ball when struck at a head speed (HS) of 35 m/s are measured. The club used is a JGR Forged I #6 (2016 model) manufactured by Bridgestone Sports Co., Ltd. and is evaluated according to the following rating criteria.

### [Rating Criteria]

Good: Total distance is at least 145.0 m
Fair: Total distance is at least 144.0 m and less than 145.0 m
NG: Total distance is less than 144.0 m

### Evaluation of Spin Rate on Approach Shots

A judgment is made based on a spin rate when a sand wedge is mounted on the golf swing robot and a ball is struck at an HS of 15 m/s. Similarly, a spin rate immediately after the ball is struck is measured by a device for measuring initial conditions. The sand wedge used is a TOURSTAGE TW-03 (loft angle 57°) 2002 model manufactured by Bridgestone Sports Co., Ltd.

### [Rating Criteria]

Good: Spin rate is 4,500 rpm or more
NG: Spin rate is less than 4,500 rpm

TABLE 6

| | | | Example | | | | Comparative Example | | | | | |
|---|---|---|---|---|---|---|---|---|---|---|---|---|
| | | | 1 | 2 | 3 | 4 | 1 | 2 | 3 | 4 | 5 | 6 |
| Flight | W#1 | Spin rate | 2,464 | 2,403 | 2,423 | 2,353 | 2,479 | 2,425 | 2,374 | 2,484 | 2,433 | 2,644 |
| | HS | (rpm) | | | | | | | | | | |
| | 54 m/s | Total (m) | 286.8 | 286.8 | 286.6 | 286.8 | 287.2 | 286.4 | 285.7 | 283.9 | 283.8 | 283.3 |
| | | Rating | Good | Good | Good | Good | Good | Good | Fair | NG | NG | NG |
| | W#1 | Spin rate | 2,681 | 2,598 | 2,635 | 2,528 | 2,678 | 2,642 | 2,609 | 2,649 | 2,605 | 2,831 |
| | HS | (rpm) | | | | | | | | | | |
| | 50 m/s | Total (m) | 270.1 | 269.6 | 271.1 | 269.3 | 273.4 | 270.6 | 268.0 | 271.0 | 270.5 | 270.6 |
| | | Rating | Good | Good | Good | Good | Good | Good | Fair | Good | Good | Good |
| | W#1 | Spin rate | 2,838 | 2,798 | 2,841 | 2,765 | 2,871 | 2,823 | 2,777 | 2,877 | 2,831 | 2,948 |
| | HS | (rpm) | | | | | | | | | | |
| | 45 m/s | Total (m) | 231.3 | 229.5 | 227.9 | 227.9 | 230.5 | 229.3 | 228.2 | 230.1 | 229.9 | 230.8 |
| | | Rating | Good | Good | Good | Good | Good | Good | Good | Good | Good | Good |
| | W#1 | Spin rate | 3,325 | 3,230 | 3,246 | 3,149 | 3,352 | 3,260 | 3,173 | 3,293 | 3,233 | 3,420 |
| | HS | (rpm) | | | | | | | | | | |
| | 40 m/s | Total (m) | 192.7 | 193.2 | 192.5 | 193.6 | 193.3 | 193.6 | 194.0 | 193.5 | 193.6 | 192.2 |
| | | Rating | Good | Good | Good | Good | Good | Good | Good | Good | Good | Good |
| | I#6 | Spin rate | 5,403 | 5,204 | 5,112 | 5,037 | 5,532 | 5,334 | 5,148 | 5,401 | 5,342 | 5,503 |
| | HS | (rpm) | | | | | | | | | | |
| | 42 m/s | Total (m) | 180.9 | 182.3 | 182.1 | 183.5 | 181.1 | 182.4 | 183.6 | 178.9 | 179.1 | 178.4 |
| | | Rating | Good | Good | Good | Good | Good | Good | Good | NG | Fair | NG |
| | I#6 | Spin rate | 5,316 | 5,105 | 5,018 | 4,928 | 5,359 | 5,185 | 5,020 | 5,217 | 5,114 | 5,566 |
| | HS | (rpm) | | | | | | | | | | |
| | 35 m/s | Total (m) | 145.1 | 145.6 | 145.1 | 145.8 | 142.6 | 144.3 | 145.9 | 146.1 | 146.4 | 144.1 |
| | | Rating | Good | Good | Good | Good | NG | Fair | Good | Good | Good | Fair |
| Approach | SW | Spin rate | 4,807 | 4,709 | 4,698 | 4,626 | 4,792 | 4,704 | 4,621 | 4,699 | 4,705 | 4,855 |
| shots | HS | (rpm) | | | | | | | | | | |
| | 15 m/s | Rating | Good | Good | Good | Good | Good | Good | Good | Good | Good | Good |

As shown in the results in Table 6, the golf balls of Comparative Examples 1 to 6 are inferior in the following respects to the golf balls according to the present invention (Examples).

In Comparative Example 1, in the hardness profile of the core, the value of (H87.5−H0) is less than 20 on the Shore C hardness scale, and the value of (H100−H75) is smaller than the value of (H75−H50). As a result, the spin rate on shots with an iron (I #6) at a head speed of HS 35 m/s is large, and the distance is inferior.

In Comparative Example 2, in the hardness profile of the core, the value of (H87.5−H0) is less than 20 on the Shore C hardness scale. As a result, the spin rate on shots with an iron (I #6) at a head speed of HS 35 m/s is large, and the distance is inferior.

In Comparative Example 3, in the hardness profile of the core, the value of (H87.5−H0) is less than 20 on the Shore C hardness scale, and the value of (H100−H75) is smaller than the value of (H75−H50). As a result, on shots with a driver (W #1) at head speeds of HS 54 m/s and HS 50 m/s, a balance between the spin rate and an actual initial velocity is inferior to that of the Examples, and thus the distance is inferior.

Comparative Example 4 has a three-piece structure without a surrounding layer, and in the hardness profile of the core, the value of (H87.5−H0) is less than 20 on the Shore C hardness scale. As a result, since the balance between the spin rate and the actual initial velocity is inferior to that of the Examples, on shots with a driver (W #1) at a head speed of HS 54 m/s and with an iron (I #6) at a head speed of HS 42 m/s, the distance is inferior.

Comparative Example 5 has a three-piece structure without a surrounding layer, and in the hardness profile of the core, the value of (H87.5−H0) is less than 20 on the Shore C hardness scale. As a result, since the balance between the spin rate and the actual initial velocity is inferior to that of the Examples, on shots with a driver (W #1) at a head speed of HS 54 m/s and with an iron (I #6) at a head speed of HS 42 m/s, the distance is inferior.

In Comparative Example 6, in the hardness profile of the core, the value of (H87.5−H0) is less than 20 on the Shore C hardness scale, and the value of (H100−H75) is smaller than the value of (H75−H50). Further, the value of (H50-H25) is smaller than the value of (H25−H0), and the value of (H87.5−H50)/(H50−H0) is smaller than 4.0. As a result, the spin rate is larger than that of the Examples, and under the two conditions of shots with a driver (W #1) at a head speed of HS 54 m/s and shots with an iron (I #6), the distance is inferior.

Japanese Patent Application No. 2025-066688 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A multi-piece solid golf ball comprising a core, a surrounding layer, an intermediate layer, and a cover, wherein the core is formed of a rubber composition, the surrounding layer is formed of a resin composition into a single layer or a plurality of layers, the intermediate layer and the cover are both formed of a resin composition into a single layer, and a relationship among surface hardnesses of the core, the surrounding layer, the intermediate layer, and the ball satisfies the following condition:
center hardness of core<surface hardness of core<surface hardness of surrounding layer-encased sphere<surface hardness of intermediate layer-encased sphere>surface hardness of ball (where hardnesses indicate Shore D hardness), and
in a hardness profile of the core, letting a Shore C hardness at the core surface be H100, a Shore C hardness at a position outside by 87.5% of a core radius from the core center be H87.5, a Shore C hardness at a position outside by 75% of the core radius from the core center be H75, a Shore C hardness at a position outside by 62.5% of the core radius from the core center be H62.5, a Shore C hardness at a position outside by 50% of the core radius from the core center be H50, a Shore C hardness at a position outside by 37.5% of the core radius from the core center be H37.5, a Shore C hardness at a position outside by 25% of the core radius from the core center be H25, a Shore C hardness at a position outside by 12.5% of the core radius from the core center be H12.5, and a Shore C hardness at the core center be H0, the following three conditions are satisfied:
(H87.5−H50)/(H50−H12.5)≥4.0
(H100−H75)>(H75−H50)>(H50−H25)>(H25−H0)
(H87.5−H0)≥20.

2. The multi-piece solid golf ball of claim 1, wherein letting a deflection when the core is compressed under a final load of 1,275 N (130 kgf) from an initial load of 98 N (10 kgf) be T (mm), the following condition is satisfied:
(H87.5−H0)×T≥75.

3. The multi-piece solid golf ball of claim 1, wherein in the hardness profile of the core, the following condition is satisfied:
(H100−H0)≥26.

4. The multi-piece solid golf ball of claim 1, wherein in the hardness profile of the core, the following condition is satisfied:
13≤(H100−H75)≤20.

5. The multi-piece solid golf ball of claim 1, wherein in the hardness profile of the core, the following condition is satisfied:
8≤(H75−H50)≤15.

6. The multi-piece solid golf ball of claim 1, wherein a difference between a specific gravity of the core and a specific gravity of the surrounding layer is within ±0.10, and a difference between the specific gravity of the core and a specific gravity of the cover is within ±0.10.

7. The multi-piece solid golf ball of claim 1, wherein a difference between the specific gravity of the surrounding layer and a specific gravity of the intermediate layer is within ±0.10, a difference between the specific gravity of the surrounding layer and the specific gravity of the cover is within ±0.10, and a difference between the specific gravity of the intermediate layer and the specific gravity of the cover is within ±0.10.

8. The multi-piece solid golf ball of claim 1, wherein in the specific gravity of the core, the specific gravity of the surrounding layer, the specific gravity of the intermediate layer, and the specific gravity of the cover, a difference between a maximum value and a minimum value among specific gravity differences between these members is within ±0.10.

9. The multi-piece solid golf ball of claim 1, wherein the core is formed of a rubber composition that includes the following components (A) to (E):
(A) a base rubber,
(B) an organic peroxide,
(C) water or a monocarboxylic acid metal salt,
(D) sulfur, and
(E) an organosulfur compound,
and a compounding amount of the component (C) is at least 0.4 part by weight and a compounding amount of the component (D) is at least 0.024 part by weight per 100 parts by weight of the component (A).

10. The multi-piece solid golf ball of claim 1, wherein the cover is formed by injection molding a single resin blend containing a thermoplastic polyurethane (I) and a polyisocyanate compound (II) as principal components, and the resin blend contains, in at least a part thereof, a polyisocyanate compound in which all isocyanate groups in one molecule remain in an unreacted state.
